(19) United States
(12) Patent Application Publication
(10) Pub. No.: US 2025/0365586 A1
(43) Pub. Date: Nov. 27, 2025

(54) BASE STATION PERFORMANCE STATISTICS COLLECTION IN DISTRIBUTED ANTENNA SYSTEM

(71) Applicant: Outdoor Wireless Networks LLC, Claremont, NC (US)

(72) Inventors: Suresh N. Sriram, Bangalore (IN); Narayana Reddy Korimilla, Bangalore (IN); Yogesh C.S, Bengaluru (IN); Syamala Saripalli, Bangalore (IN); Sudarshana Varadappa, Bangalore (IN)

(73) Assignee: Outdoor Wireless Networks LLC, Claremont, NC (US)

(21) Appl. No.: 18/874,973

(22) PCT Filed: Jun. 7, 2023
(86) PCT No.: PCT/US2023/024678

§ 371 Date: Dec. 13, 2024

(30) Foreign Application Priority Data
Jun. 13, 2022 (IN) 202241033628

(51) Int. Cl. H04W 24/02; H04B 7/022

(52) U.S. Cl. CPC H04W 24/02; H04B 7/022

(57) ABSTRACT

Systems and methods for base station performance statistics collection in distributed antenna systems are provided. In certain embodiment, a system includes a distributed antenna system comprising at least one processor, wherein executable code directs the at least one processor to decode messages from and to user equipment in communication with the distributed antenna system. The system also includes a database, wherein the at least one processor stores parameters identified in the decoded messages in the database. Further, performance of the distributed antenna system is adjusted based on the stored parameters.

### CROSS-REFERENCE TO RELATED APPLICATIONS

This application claims the benefit of Indian Provisional Application 202241033628, filed on Jun. 13, 2022, which is hereby incorporated herein by reference in its entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units” or “radio units”). Each access point can be coupled directly to one or more central access nodes. Also, each access point can be coupled indirectly via one or more other remote units or via one or more intermediary or expansion units or nodes (also referred to here as “transport expansion nodes (TENs)”). A DAS is typically used to improve the coverage provided by one or more base stations coupled to the central access nodes. These base stations can be coupled to the one or more central access nodes via one or more cables or a wireless connection, for example, using one or more donor antennas. The wireless service provided by the base stations can include commercial cellular service or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals for radiation from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits the one or more uplink transport signals to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, receiving the uplink signals involves, among other things, summing uplink signals received from the multiple access points to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

Traditionally, a DAS lacks access to information related to the performance of individual UEs served by the DAS. Therefore, it has typically not been possible to track the performance of a DAS for each donor base station at the UE level. The incapability of tracking the DAS performance at the UE level increases the difficulty in monitoring and optimizing the performance of the DAS separately from the donor base stations. For example, in a neutral-host, or similar DAS deployment, a DAS can be owned and operated by one party (referred to here as the “owner”) that, in turn, provides access to the DAS to other parties (referred to here as “tenants”). The provision of access to other parties allows the tenants' base stations to couple to the DAS. In such deployments, when performance issues arise, it can be difficult to determine if the issue is caused by a tenant's base station or by the owner's DAS. The unknown source of the issue can impact determining compliance with any related service-level agreements (SLAs) and modifying the configuration of the DAS or base stations to resolve any performance issues.

### SUMMARY

Systems and methods for base station performance statistics collection in distributed antenna systems are provided. In certain embodiment, a system includes a distributed antenna system comprising at least one processor, wherein executable code directs the at least one processor to decode messages from and to user equipment in communication with the distributed antenna system. The system also includes a database, wherein the at least one processor stores parameters identified in the decoded messages in the database. Further, performance of the distributed antenna system is adjusted based on the stored parameters.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIGS. 1A-1C are block diagrams illustrating exemplary embodiments of a virtualized DAS according to an aspect of the present disclosure;

FIG. 2 is a block diagram illustrating an exemplary embodiment of an access point for use in a virtualized DAS according to an aspect of the present disclosure;

FIGS. 3A-3D are block diagrams illustrating exemplary embodiments of a virtualized DAS having access points coupled to virtual MUs according to an aspect of the present disclosure;

FIG. 4 is a block diagram illustrating an exemplary embodiment of a virtualized DAS where an RF interface bypasses a virtualized MU according to an aspect of the present disclosure;

FIG. 5 is a flowchart diagram of a method for collecting base station performance statistics in a distributed antenna system according to an aspect of the present disclosure; and

FIG. 6 is a flowchart diagram of a method for collecting base station performance statistics.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and methods described herein allow for the collection of base station performance statistics in a DAS System. In certain embodiments, a DAS may decode incoming data from and control messages to a UE to acquire key performance indicators (KPI). The DAS may then provide the KPIs to an operator. Thus, an operator may improve base transceiver system (BTS) or DAS operational parameters to improve network performance. The operator or other network component may improve the network performance at one time or periodically using built-in intelligence that monitors the observed metrics and improves the network performance based on the observed metrics.

In certain embodiments, a DAS is configured to decode data provided by donor base stations and use the decoded information to determine KPIs within the DAS. These KPIs (or information derived therefrom) can be used for various purposes within the operation of the DAS. For example, such information can be presented to the operator of the DAS, the operator of the base stations, or otherwise communicated to a management or control entity of the DAS, base station, or radio access network (RAN), (for example, by communicating such data to a DAS management system or to a near real-time RAN intelligent controller (NR RIC) or other entity that is a part of the service, management, and orchestration (SMO) framework). The provision of the data enables the operator to adjust operational parameters (or otherwise adjust the configuration) of the donor base stations and/or the DAS to achieve better performance. These adjustments can be performed on a one-time basis, periodically, or in response to a detected condition. Such adjustments can be performed manually (in which case the KPIs can be used by the person making the adjustment) or automatically.

In general, the DAS can acquire the data by having a relevant entity in the DAS (for example, a master unit of a DAS) decode data communicated via the DAS (such as decoding Downlink Control Information (DCI) communicated via the DAS) to determine UE-level information about the service provided using the DAS and to make uplink measurements such as signal-to-interference-plus-noise ratio (SINR) measurements on a per-UE-level.

Examples of potential key performance metrics or indicators may include: Average & Peak UE/TTI, Average & Peak PRB Utilization, Average & Peak IMCS, Average & Peak UL SINR, Average & Peak PRACH Attempts, Average & Peak DL Throughput, Average & Peak UL throughput, Average Interference Per deployed RU, RU Wise Traffic Activity, Zonal Combining Efficiency, Muting Efficiency, DL HARQ Retransmission, UL HARQ Retransmission, among other potential key performance metrics.

In some embodiments, KPIs may be gathered for a donor base station that includes a distributed unit (DU) coupled to the DAS (for example, the DU may be coupled to a master unit (MU) of the DAS) via an O-RAN fronthaul interface (for example, where the user-plane data is communicated as frequency-domain IQ data). In general, in this embodiment, downlink fronthaul data is received from the donor base station (a donor DU in this example). The downlink fronthaul data comprises O-RAN control-plane (C-plane) packets and O-RAN user-plane (U-plane) packets (and can also include O-RAN synchronization-plane (S-plane) packets and O-RAN management-plane (M-plane) packets as well).

In certain embodiments, an entity within the DAS (for example, an MU) may perform some processing that causes the entity to decode the O-RAN control-plane packets. The entity may also decode the O-RAN user-plane packets using the decoded C-plane config data. Regarding downlink U-plane data, the entity may perform blind decoding of DCI with all possible RNTIs. If no DCI is decoded from the U-plane data, the entity may continue to monitor C-plane packets for a next slot. If no DCIs are decoded in the DCI decode process, the entity may store SFN, SF, and a slot with a number of DCIs decoded. For each decoded DCI, the entity may store DCI decoded parameters in a database that may include the following: DCI format, MCS, RV Idx, NDI, HARQ ID, time-frequency resources, mapping type, frequency hopping, TPC info, among other DCI decoded parameters. In some embodiments, regarding uplink U-plane data, the entity may measure RSSI, SINR, Interference, signal quality, and other matrix. Further, the entity may store estimated UL parameters in a database by respective SFN/SF/Slot.

In further embodiments, an entity may perform a statistics monitoring process. The entity may periodically monitor gathered statistics at a rate T. Additionally, the entity may monitor some or all of the gathered statistics for triggers, such as specific conditions or thresholds. When the trigger or specific condition is identified, the entity may read the stored statistics from the database for a number N of slots. When the data is gathered, the entity may report the statistics for the N slots to the operator or other entity. The operator or other entity may use the gathered statistics for additional monitoring and improvement of the network performance. In some embodiments, the entity that gathered the statistics may also adjust the performance of the network.

Although the above example was described as being implemented for use with a donor base station entity that is coupled to the DAS using an O-RAN interface, it is to be understood that the solution described here is not limited to such an example. For example, the solution described here can be used with donor base station entities coupled to the DAS using other packet-based fronthaul interfaces (such as eCPRI or RoE). Also, the solution described here can be used with donor base station entities coupled to the DAS using another analog RF interface or a CPRI interface (for example, where the fronthaul data is processed to recover the appropriate control-plane or control-channel information and user-plane or shared channel data).

The ideas described above can be implemented in the systems described below.

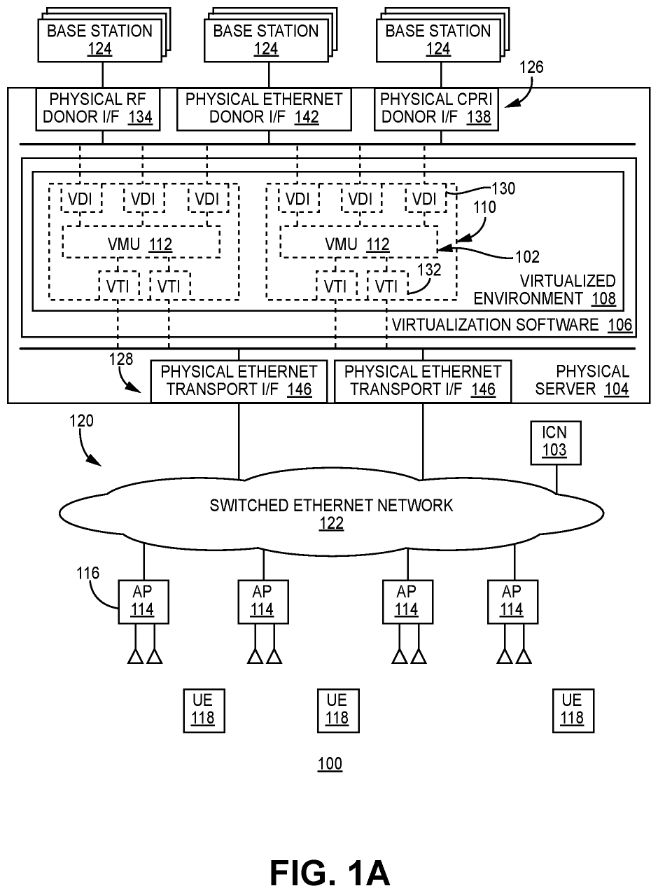

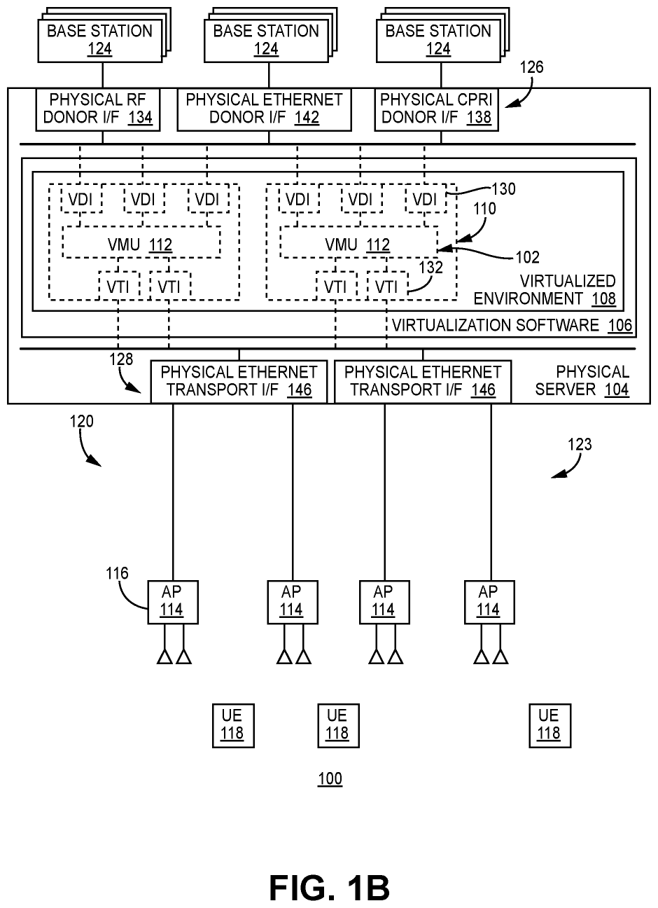

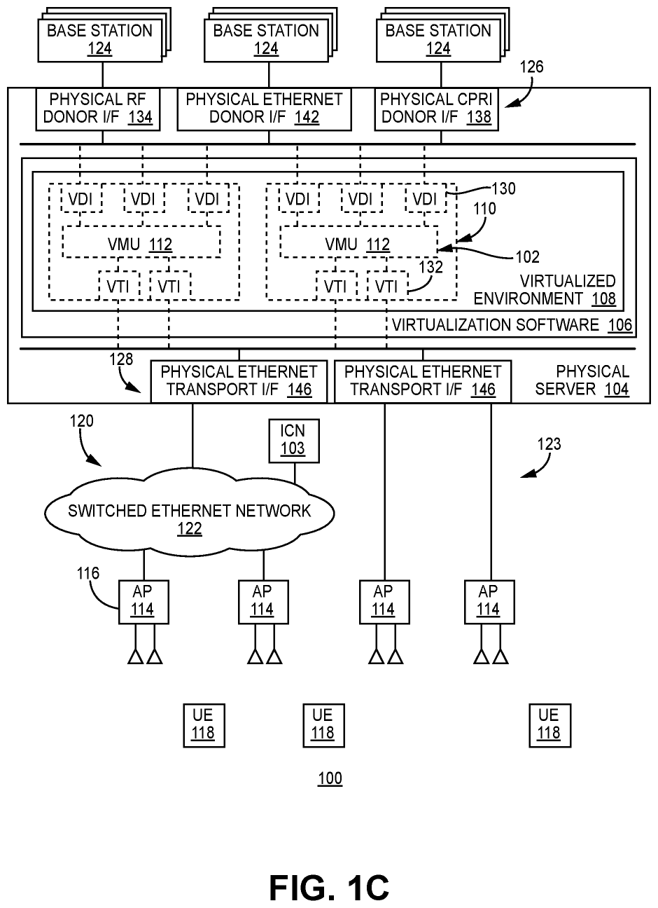

FIGS. 1A-1C are block diagrams illustrating one exemplary embodiment of a virtualized DAS (vDAS) 100. In the exemplary embodiment of the virtualized DAS 100 shown in FIGS. 1A-1C, one or more nodes or functions of a traditional DAS (such as a master unit or CAN) are implemented using one or more virtual network functions (VNFs) 102 executing on one or more physical server computers (also referred to here as “physical servers” or just “servers”) 104 (for example, one or more commercial-off-the-shelf (COTS) servers of the type that are deployed in data centers or “clouds” maintained by enterprises, communication service providers, or cloud services providers).

Each such physical server computer 104 is configured to execute software that is configured to implement the various functions and features described here as being implemented by the associated VNF 102. Each such physical server computer 104 comprises one or more programmable processors for executing such software. The software comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each such physical server computer 104 also includes memory for storing the program instructions (and any related data) during execution by the respective programmable processor.

In the example shown in FIGS. 1A-1C, virtualization software 106 is executed on each physical server computer 104 in order to provide a virtualized environment 108 in which one or more one or more virtual entities 110 (such as one or more virtual machines and/or containers) are used to deploy and execute the one or more VNFs 102 of the vDAS 100. In the following description, it should be understood that references to “virtualization” are intended to refer to, and include within their scope, any type of virtualization technology, including “container” based virtualization technology (such as, but not limited to, Kubernetes).

In the example shown in FIGS. 1A-1C, the vDAS 100 comprises at least one virtualized master unit (vMU) 112 and a plurality of access points (APs) (also referred here to as “remote antenna units” (RAUs) or “radio units” (RUs)) 114. Each vMU 112 is configured to implement at least some of the functions normally carried out by a physical master unit or CAN in a traditional DAS.

Each of the vMU 112 is implemented as a respective VNF 102 deployed on one or more of the physical servers 104. Each of the APs 114 is implemented as a physical network function (PNF) and is deployed in or near a physical location where coverage is to be provided.

Each of the APs 114 includes, or is otherwise coupled to, one or more coverage antennas 116 via which downlink radio frequency (RF) signals are radiated for reception by user equipment (UEs) 118 and via which uplink RF signals transmitted from UEs 118 are received. Although only two coverage antennas 116 are shown in FIGS. 1A-1C for ease of illustration, it is to be understood that other numbers of coverage antennas 116 can be used. Each of the APs 114 is communicatively coupled to the respective one or more vMU 112 (and the physical server computers 104 on which the vMUs 112 are deployed) using a fronthaul network 120. The fronthaul network 120 used for transport between each vMU 112 and the APs 114 can be implemented in various ways. Various examples of how the fronthaul network 120 can be implemented are illustrated in FIGS. 1A-1C. In the example shown in FIG. 1A, the fronthaul network 120 is implemented using a switched Ethernet network 122 that is used to communicatively couple each AP 114 to each vMU 112 serving that AP 114. That is, in contrast to a traditional DAS in which each AP is coupled to each CAN serving it using only point-to-point links, in the vDAS 100 shown in FIG. 1A, each AP 114 is coupled to each vMU 112 serving it using at least some shared communication links.

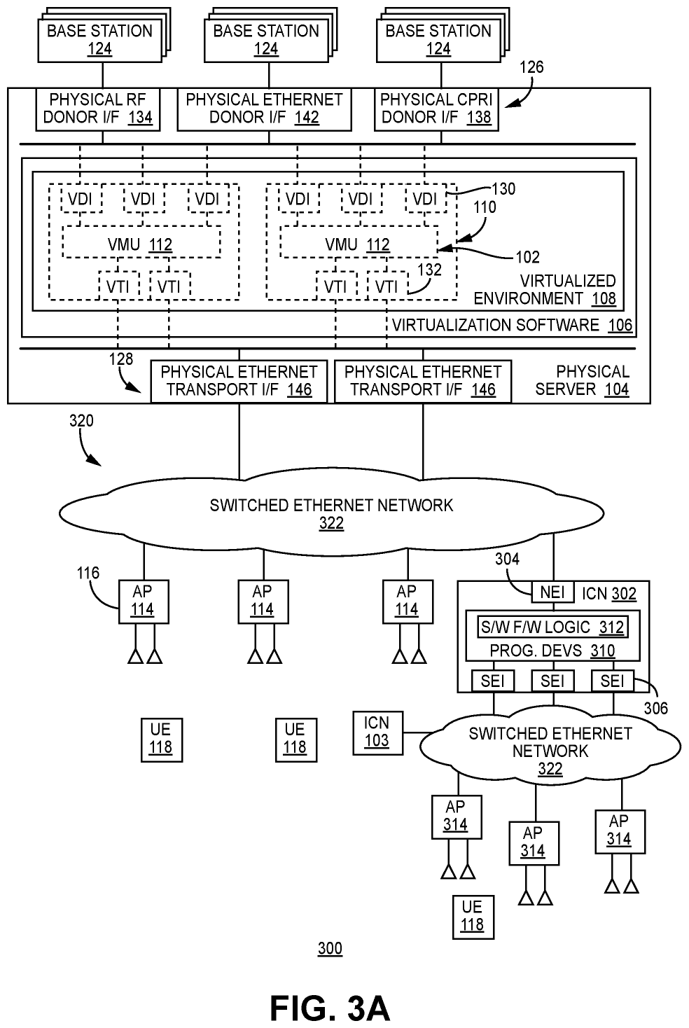

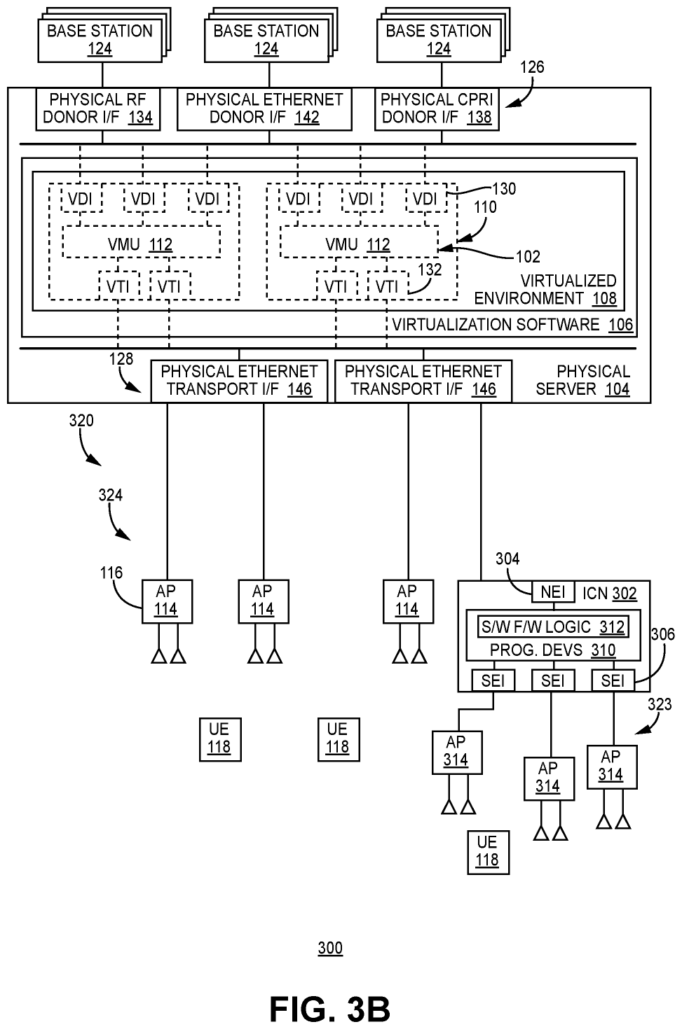

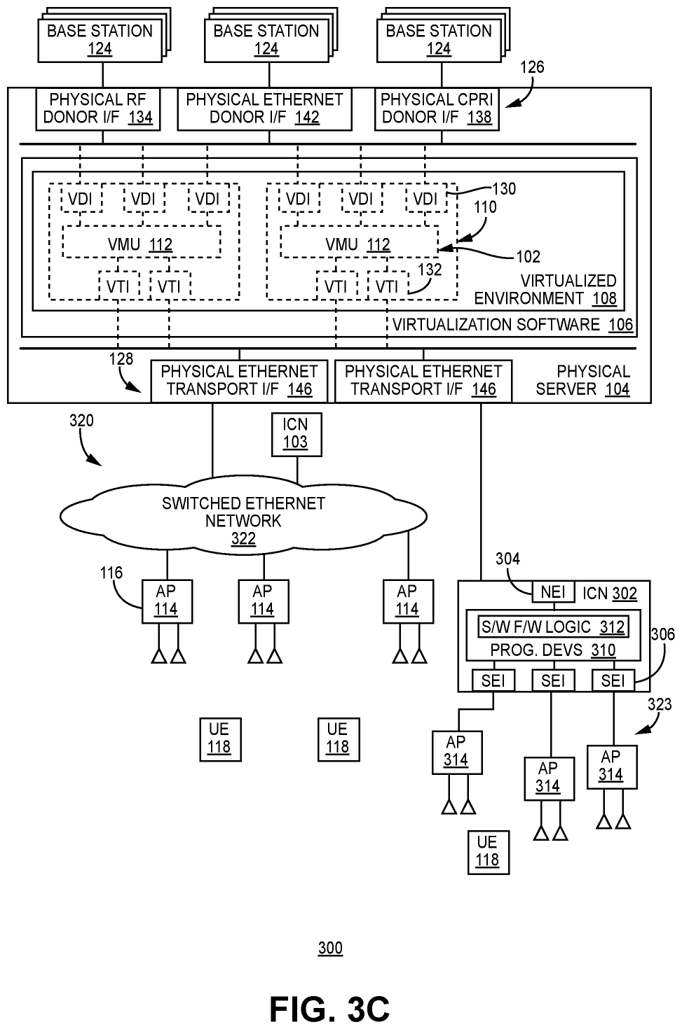

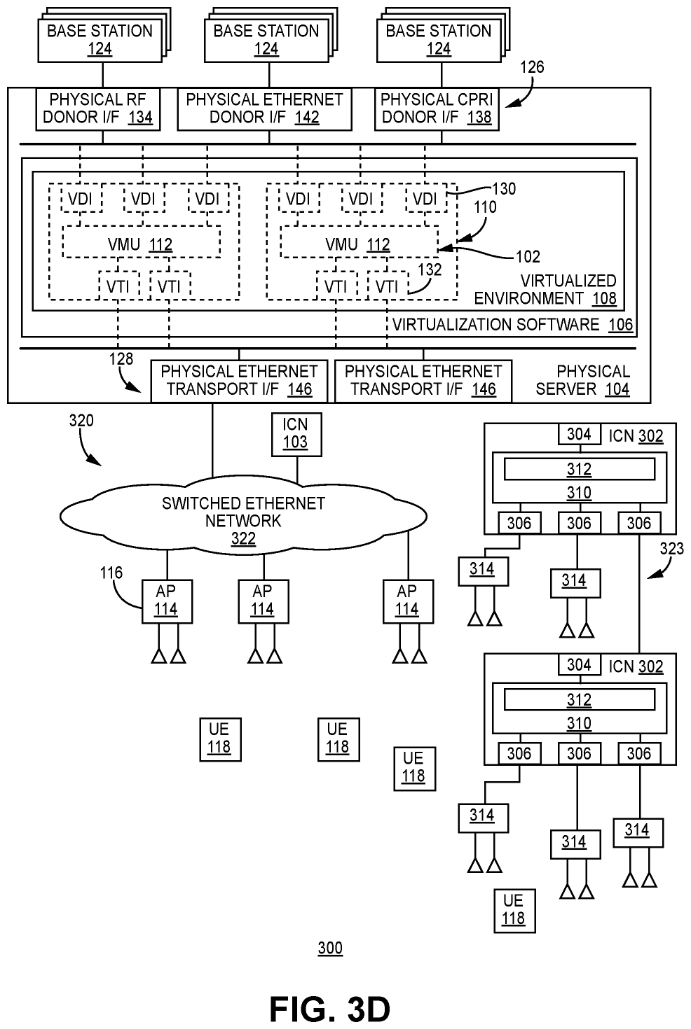

In the example shown in FIG. 1B, the fronthaul network 120 is implemented using only point-to-point Ethernet links 123, where each AP 114 is coupled to each serving vMU 112 serving it via a respective one or more point-to-point Ethernet links 123. In the example shown in FIG. 1C, the fronthaul network 120 is implemented using a combination of a switched Ethernet network 122 and point-to-point Ethernet links 123, where at least one AP 114 is coupled to a vMU 112 serving it at least in part using the switched Ethernet network 122 and at least one AP 114 where at least one AP 114 is coupled to a vMU 112 serving it at least in part using at least one point-to-point Ethernet link 123. FIGS. 3A-3D are block diagrams illustrating other examples in which one or more intermediate combining nodes (ICNs) 302 are used. The examples shown in FIGS. 3A-3D are described below. It is to be understood, however, that FIGS. 1A-1C and 3A-3D illustrate only a few examples of how the fronthaul network (and the vDAS more generally) can be implemented and that other variations are possible.

The vDAS 100 is configured to be coupled to one or more base stations 124 in order to improve the coverage provided by the base stations 124. That is, each base station 124 is configured to provide wireless capacity, whereas the vDAS 100 is configured to provide improved wireless coverage for the wireless capacity provided by the base station 124. As used here, unless otherwise explicitly indicated, references to “base station” include both (1) a “complete” base station that interfaces with the vDAS 100 using the analog radio frequency (RF) interface that would otherwise be used to couple the complete base station to a set of antennas as well as (2) a first portion of a base station 124 (such as a baseband unit (BBU), distributed unit (DU), or similar base station entity) that interfaces with the vDAS 100 using a digital fronthaul interface that would otherwise be used to couple that first portion of the base station to a second portion of the base station (such as a remote radio head (RRH), radio unit (RU), or similar radio entity). In the latter case, different digital fronthaul interfaces can be used (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface), or an O-RAN fronthaul interface) and different functional splits can be supported (including, for example, functional split 8, functional split 7-2, and functional split 6). The O-RAN Alliance publishes various specifications for implementing RANs in an open manner. (“O-RAN” is an acronym that also stands for “Open RAN,” but in this description references to “O-RAN” should be understood to be referring to the O-RAN Alliance and/or entities or interfaces implemented in accordance with one or more specifications published by the O-RAN Alliance.)

Each base station 124 coupled to the vDAS 100 can be co-located with the vMU 112 to which it is coupled. A co-located base station 124 can be coupled to the vMU 112 to which it is coupled using one or more point-to-point links (for example, where the co-located base station 124 comprises a 4G LTE BBU supporting a CPRI fronthaul interface, the 4G LTE BBU can be coupled to the vMU 112 using one or more optical fibers that directly connect the BBU to the vMU 112) or a shared network (for example, where the co-located base station 124 comprises a DU supporting an Ethernet-based fronthaul interface (such as an O-RAN or eCPRI fronthaul interface), the co-located DU can be coupled to the vMU 112 using a switched Ethernet network). Each base station 124 coupled to the vDAS 100 can also be located remotely from the vMU 112 to which it is coupled. A remote base station 124 can be coupled to the vMU 112 to which it is coupled via a wireless connection (for example, by using a donor antenna to wirelessly couple the remote base station 124 to the vMU 112 using an analog RF interface) or via a wired connection (for example, where the remote base station 124 comprises a DU supporting an Ethernet-based fronthaul interface (such as an O-RAN or eCPRI fronthaul interface), the remote DU can be coupled to the vMU 112 using an Internet Protocol (IP)-based network such as the Internet).

The vDAS 100 described here is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100). For example, multiple vMUs 112 can be instantiated, where a different group of one or more vMUs 112 can be used with each of the wireless service operators (and the base stations 124 of that wireless service operator). The vDAS 100 described here is especially well-suited for use in such deployments because vMUs 112 can be easily instantiated in order to support additional wireless service operators. This is the case even if an additional physical server computer 104 is needed in order to instantiate a new vMU 112 because such physical server computers 104 are either already available in such deployments or can be easily added at a low cost (for example, because of the COTS nature of such hardware). Other vDAS entities implemented in virtualized manner (for example, ICNs) can also be easily instantiated or removed as needed based on demand.

In the example shown in FIGS. 1A-1C, the physical server computer 104 on which each vMU 112 is deployed includes one or more physical donor interfaces 126 that are each configured to communicatively couple the vMU 112 (and the physical server computer 104 on which it is deployed) to one or more base stations 124. Also, the physical server computer 104 on which each vMU 112 is deployed includes one or more physical transport interfaces 128 that are each configured to communicatively couple the vMU 112 (and the physical server computer 104 on which it is deployed) to the fronthaul network 120 (and ultimately the APs 114 and ICNs). Each physical donor interface 126 and physical transport interface 128 is a physical network function (PNF) (for example, implemented as a Peripheral Computer Interconnect Express (PCIe) device) deployed in or with the physical server computer 104.

In the example shown in FIGS. 1A-1C, each physical server computer 104 on which each vMU 112 is deployed includes or is in communication with separate physical donor and transport interfaces 126 and 128; however, it is to be understood that in other embodiments a single set of physical interfaces 126 and 128 can be used for both donor purposes (that is, communication between the vMU 112 to one or more base stations 124) and for transport purposes (that is, communication between the vMU 112 and the APs 114 over the fronthaul network 120).

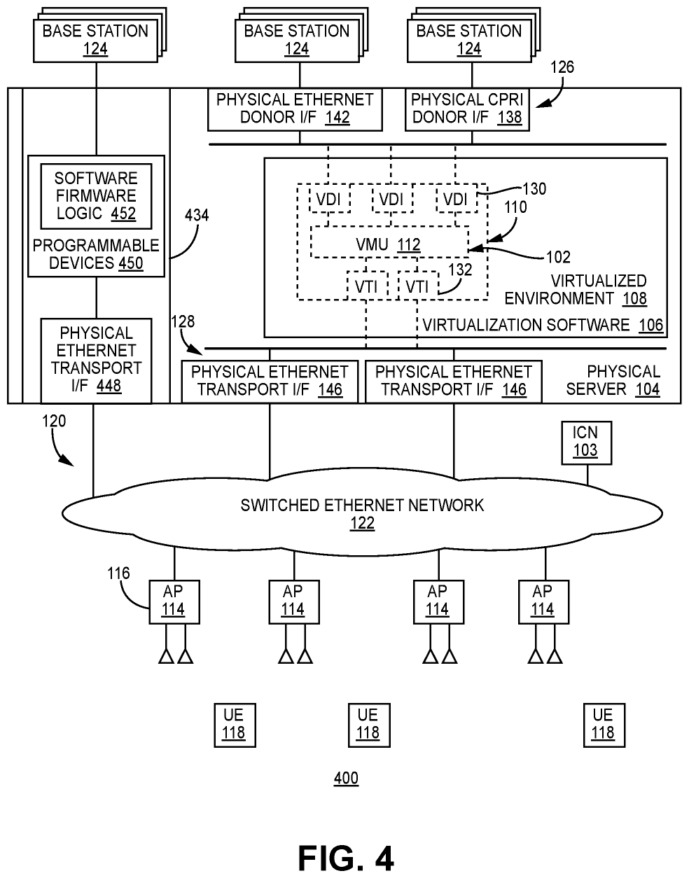

In the exemplary embodiment shown in FIGS. 1A-1C, the physical donor interfaces 126 comprise one or more physical RF donor interfaces (also referred to here as “physical RF donor cards”) 134. Each physical RF donor interface 134 is in communication with one or more vMUs 112 executing on the physical server computer 104 in which that physical RF donor interface 134 is deployed (for example, by implementing the physical RF donor interface 134 as a card inserted in the physical server computer 104 and communicating over a PCIe lane with a central processing unit (CPU) used to execute each such vMU 112). Each physical RF donor interface 134 includes one or more sets of physical RF ports (not shown) to couple the physical RF donor interface 134 to one or more base stations 124 using an analog RF interface. Each physical RF donor interface 134 is configured, for each base station 124 coupled to it, to receive downlink analog RF signals from the base station 124 via respective RF ports, convert the received downlink analog RF signals to digital downlink time-domain user-plane data, and output it to a vMU 112 executing on the same server computer 104 in which that RF donor interface 134 is deployed. Also, each physical RF donor interface 134 is configured, for each base station 124 coupled to it, to receive combined uplink time-domain user-plane data from the vMU 112 for that base station 124, convert the received combined uplink time-domain user-plane data to uplink analog RF signals, and output them to the base station 124. Moreover, the digital downlink time-domain user-plane data produced, and the digital uplink time-domain user-plane data received, by each physical RF donor interface 134 can be in the form of real digital values or complex (that is, in-phase and quadrature (IQ)) digital values and at baseband (that is, centered around 0 Hertz) or with a frequency offset near baseband or an intermediate frequency (IF). Alternatively, as described in more detail below in connection with FIG. 4, one or more of the physical RF donor interfaces can be configured to by-pass the vMU 112 and instead, for the base stations 124 coupled to that physical RF donor interface, have that physical RF donor interface perform some of the functions described here as being performed by the vMU 112 (including the digital combining or summing of user-plane data).

In the exemplary embodiment shown in FIGS. 1A-1C, the physical donor interfaces 126 also comprise one or more physical CPRI donor interfaces (also referred to here as “physical CPRI donor cards”) 138. Each physical CPRI donor interface 138 is in communication with one or more vMUs 112 executing on the physical server computer 104 in which that physical CPRI donor interface 138 is deployed (for example, by implementing the physical CPRI donor interface 138 as a card inserted in the physical server computer 104 and communicating over a PCIe lane with a CPU used to execute each such vMU 112). Each physical CPRI donor interface 138 includes one or more sets of physical CPRI ports (not shown) to couple the physical CPRI donor interface 138 to one or more base stations 124 using a CPRI interface. More specifically, in this example, each base station 124 coupled to the physical CPRI donor interface 138 comprises a BBU or DU that is configured to communicate with a corresponding RRH or RU using a CPRI fronthaul interface. Each physical CPRI donor interface 138 is configured, for each base station 124 coupled to it, to receive from the base station 124 via a CPRI port digital downlink data formatted for the CPRI fronthaul interface, extract the digital downlink data, and output it to a vMU 112 executing on the same server computer 104 in which that CPRI donor interface 138 is deployed. Also, each physical CPRI donor interface 138 is configured, for each base station 124 coupled to it, to receive digital uplink data including combined digital user-plane data from the vMU 112, format it for the CPRI fronthaul interface, and output the CPRI formatted data to the base station 124 via the CPRI ports.

In the exemplary embodiment shown in FIGS. 1A-1C, the physical donor interfaces 126 also comprise one or more physical donor Ethernet interfaces 142. Each physical donor Ethernet interface 142 is in communication with one or more vMUs 112 executing on the physical server computer 104 in which that physical donor Ethernet interface 142 is deployed (for example, by implementing the physical donor Ethernet interface 142 as a card or module inserted in the physical server computer 104 and communicating over a PCIe lane with a CPU used to execute each such vMU 112). Each physical donor Ethernet interface 142 includes one or more sets of physical donor Ethernet ports (not shown) to couple the physical donor Ethernet interface 142 to one or more base stations 124 so that each vMU 112 can communicate with the one or more base stations 124 using an Ethernet-based digital fronthaul interface (for example, an O-RAN or eCPRI fronthaul interface). More specifically, in this example, each base station 124 coupled to the physical donor Ethernet interface 142 comprises a BBU or DU that is configured to communicate with a corresponding RRH or RU using an Ethernet-based fronthaul interface. Each donor Ethernet interface 142 is configured, for each base station 124 coupled to it, to receive from the base station 124 digital downlink fronthaul data formatted as Ethernet data, extract the digital downlink fronthaul data, and output it to a vMU 112 executing on the same server computer 104 in which that donor Ethernet interface 142 is deployed. Also, each physical donor Ethernet interface 142 is configured, for each base station 124 coupled to it, to receive digital uplink fronthaul data including combined digital user-plane data for the base station 124 from the vMU 112, output it to the base station 124 via one or more Ethernet ports 144. In some implementations, each physical donor Ethernet interface 142 is implemented using standard Ethernet interfaces of the type typically used with COTS physical servers.

In the exemplary embodiment shown in FIGS. 1A-1C, the physical transport interfaces 128 comprise one or more physical Ethernet transport interfaces 146. Each physical transport Ethernet interface 146 is in communication with one or more vMUs 112 executing on the physical server computer 104 in which that physical transport Ethernet interface 146 is deployed (for example, by implementing the physical transport Ethernet interface 146 as a card or module inserted in the physical server computer 104 and communicating over a PCIe lane with a CPU used to execute each such vMU 112). Each physical transport Ethernet interface 146 includes one or more sets of Ethernet ports (not shown) to couple the physical transport Ethernet interface 146 to the Ethernet cabling used to implement the fronthaul network 120 so that each vMU 112 can communicate with the various APs 114 and ICNs. In some implementations, each physical transport Ethernet interface 146 is implemented using standard Ethernet interfaces of the type typically used with COTS physical servers.

In this exemplary embodiment, the virtualization software 106 is configured to implement within the virtual environment 108 a respective virtual interface for each of the physical donor interfaces 126 and physical transport Ethernet interfaces 146 in order to provide and control access to the associated physical interface by each vMU 112 implemented within that virtual environment 108. That is, the virtualization software 106 is configured so that the virtual entity 110 used to implement each vMU 112 includes or communicates with a virtual donor interface (VDI) 130 that virtualizes and controls access to the underlying physical donor interface 126. Each VDI 130 can also be configured to perform some donor-related signal or other processing (for example, each VDI 130 can be configured to process the user-plane and/or control-plane data provided by the associated physical donor interface 126 in order to determine timing and system information for the base station 124 and associated cell). Also, although each VDI 130 is illustrated in the examples shown in FIGS. 1A-1C as being separate from the respective vMU 112 with which it is associated, it is to be understood that each VDI 130 can also be implemented as a part of the vMU 112 with which it is associated. Likewise, the virtualization software 106 is configured so that the virtual entity 110 used to implement each vMU 112 includes or communicates with a virtual transport interface (VTI) 132 that virtualizes and controls access to the underlying physical transport interface 128. Each VTI 132 can also be configured to perform some transport-related signal or other processing. Also, although each VTI 132 is illustrated in the examples shown in FIGS. 1A-1C as being separate from the respective vMU 112 with which it is associated, it is to be understood that each VTI 132 can also be implemented as a part of the vMU 112 with which it is associated. For each port of each physical Ethernet transport interface 146, the physical Ethernet transport interface 146 (and each corresponding virtual transport interface 132) is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

The vDAS 100 is configured to serve each base station 124 using a respective subset of APs 114 (which may include less than all of the APs 114 of the vDAS 100). The subset of APs 114 used to serve a given base station 124 is also referred to here as the “simulcast zone” for that base station 124. Typically, the simulcast zone for each base station 124 includes multiple APs 114. In this way, the vDAS 100 increases the coverage area for the capacity provided by the base stations 124. Different base stations 124 (including different base stations 124 from different wireless service operators in deployments where multiple wireless service operators share the same vDAS 100) can have different simulcast zones defined for them. Also, the simulcast zone for each served base station 124 can change (for example, based on a time of day, day of the week, etc., and/or in response to a particular condition or event).

In general, the wireless coverage of a base station 124 served by the vDAS 100 is improved by radiating a set of downlink RF signals for that base station 124 from the coverage antennas 116 associated with the multiple APs 114 in that base station's simulcast zone and by producing a single set of uplink base station signals by a combining or summing process that uses inputs derived from the uplink RF signals received via the coverage antennas 116 associated with the multiple APs 114 in that base station's simulcast zone, where the resulting final single set of uplink base station signals is provided to the base station 124.

This combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114). Each unit of the vDAS 100 that performs the combining or summing process for a given base station 124 receives uplink transport data for that base station 124 from that unit's one or more “southbound” entities, combines or sums corresponding user-plane data contained in the received uplink transport data for that base station 124 as well as any corresponding user-plane data generated at that unit from uplink RF signals received via coverage antennas 116 associated with that unit (which would be the case if the unit is a “daisy-chained” AP 114), generates uplink transport data containing the combined user-plane data for that base station 124, and communicates the resulting uplink transport data for that base station 124 to the appropriate “northbound” entities coupled to that unit. As used here, “southbound” refers to traveling in a direction “away,” or being relatively “farther,” from the vMU 112 and base station 124, and “northbound” refers to traveling in a direction “towards,” or being relatively “closer” to, the vMU 112 and base station 124. As used here, the southbound entities of a given unit are those entities that are subtended from that unit in the southbound direction, and the northbound entities of a given unit are those entities from which the given unit is itself subtended from in the southbound direction.

The vDAS 100 can also include one or more intermediary or intermediate combining nodes (ICNs) (also referred to as “expansion” units or nodes). For each base station 124 that the vDAS 100 serves using an ICN, the ICN is configured to receive a set of uplink transport data containing user-plane data for that base station 124 from a group of southbound entities (that is, from APs 114 and/or other ICNs) and perform the uplink combining or summing process described above in order to generate uplink transport data containing combined user-plane data for that base station 124, which the ICN transmits northbound towards the vMU 112 serving that base station 124. Each ICN also forwards northbound all other uplink transport data (for example, uplink management-plane and synchronization-plane data) received from its southbound entities. In the embodiments shown in FIGS. 1A, 1C, 3A, 3C, and 3D, the ICN 103 is communicatively coupled to its northbound entities and its southbound entities using the switched Ethernet network 122 and is used only for communicating uplink transport data and is not used for communicating downlink transport data. In such embodiments, each ICN 103 includes one or more Ethernet interfaces to communicatively couple the ICN 103 to the switched Ethernet network 122. For example, the ICN 103 can include one or more Ethernet interfaces that are used for communicating with its northbound entities and one or more Ethernet interfaces that are used for communicating with its southbound entities. Alternatively, the ICN 103 can communicate with both its northbound and southbound entities via the switched Ethernet network 122 using the same set of one or more Ethernet interfaces.

In some embodiments, the vDAS 100 is configured so that some ICNs also communicate (forward) southbound downlink transport data received from their northbound entities (in addition to communicating uplink transport data). In the embodiments shown in FIGS. 3A-3D, the ICNs 302 are used in this way. The ICNs 302 are communicatively coupled to their northbound entities and their southbound entities using point-to-point Ethernet links 123 and are used for communicating both uplink transport data and downlink transport data.

Generally, ICNs can be used to increase the number of APs 114 that can be served by a vMU 112 while reducing the processing and bandwidth load relative to having the additional APs 114 communicate directly with the vMU 112. Each ICN can be implemented as a physical network function using dedicated, special-purpose hardware. Alternatively, each ICN can be implemented as a virtual network function running on a physical server. For example, each ICN can be implemented in the same manner as the vMU 112.

Also, one or more APs 114 can be configured in a “daisy-chain” or “ring” configuration in which transport data for at least some of those APs 114 is communicated via at least one other AP 114. Each such AP 114 would also perform the user-plane combining or summing process described above for any base station 124 served by that AP 114 in order to combine or sum user-plane data generated at that AP 114 from uplink RF signals received via its associated coverage antennas 116 with corresponding uplink user-plane data for that base station 124 received from any southbound entity subtended from that AP 114. Such an AP 114 also forwards northbound all other uplink transport data received from any southbound entity subtended from it and forwards to any southbound entity subtended from it all downlink transport received from its northbound entities.

In general, the vDAS 100 is configured to receive a set of downlink base station signals from each served base station 124, generate downlink base station data for the base station 124 from the set of downlink base station signals, generate downlink transport data for the base station 124 that is derived from the downlink base station data for the base station 124, and communicate the downlink transport data for the base station 124 over the fronthaul network 120 of the vDAS 100 to the APs 114 in the simulcast zone of the base station 124. Each AP 114 in the simulcast zone for each base station 124 is configured to receive the downlink transport data for that base station 124 communicated over the fronthaul network 120 of the vDAS 100, generate a set of downlink analog radio frequency (RF) signals from the downlink transport data, and wirelessly transmit the set of downlink analog RF signals from the respective set of coverage antennas 116 associated with that AP 114. The downlink analog RF signals are radiated for reception by UEs 118 served by the base station 124. As described above, the downlink transport data for each base station 124 can be communicated to each AP 114 in the base station's simulcast zone via one or more intermediary units of the vDAS 100 (such as one or more ICNs or daisy-chained APs 114). Also, as described above, if an AP 114 is part of a daisy chain, the AP 114 will also forward to any southbound entity subtended from that AP 114 all downlink transport received from its northbound entities.

The vDAS 100 is configured so that a vMU 112 associated with at least one base station 124 performs at least some of the processing related to generating the downlink transport data that is derived from the downlink base station data for that base station 124 and communicating the downlink transport data for the base station 124 over the fronthaul network 120 of the vDAS 100 to the APs 114 in the simulcast zone of the base station 124. In exemplary embodiments shown in FIGS. 1A-1C, a respective vMU 112 does this for all of the served base stations 124.

In general, each AP 114 in the simulcast zone of a base station 124 receives one or more uplink RF signals transmitted from UEs 118 being served by the base station 124. Each such AP 114 generates uplink transport data derived from the one or more uplink RF signals and transmits it over the fronthaul network 120 of the vDAS 100. As noted above, as a part of doing this, if the AP 114 is a part of a daisy chain, the AP 114 performs the user-plane combining or summing process described above for the base station 124 in order to combine or sum user-plane data generated at that AP 114 from uplink RF signals received via its associated coverage antennas 116 for the base station 124 with any corresponding uplink user-plane data for that base station 124 received from any southbound entity subtended from that AP 114. Such a daisy-chained AP 114 also forwards northbound to its northbound entities all other uplink transport data received from any southbound entity subtended from that AP 114. As described above, the uplink transport data for each base station 124 can be communicated from each AP 114 in the base station's simulcast zone over the fronthaul network 120 via one or more intermediary units of the vDAS 100 (such as one or more ICNs or daisy-chained APs 114).

The vDAS 100 is configured to receive uplink transport data for each base station 124 from the fronthaul network 120 of the vDAS 100, use the uplink transport data for the base station 124 received from the fronthaul network 120 of the vDAS 100 to generate uplink base station data for the base station 124, generate a set of uplink base station signals from the uplink base station data for the base station 124, and provide the uplink base station signals to the base station 124. As a part of doing this, the user-plane combining or summing process can be performed for the base station 124.

The vDAS 100 is configured so that a vMU 112 associated with at least one base station 124 performs at least some of the processing related to using the uplink transport data for the base station 124 received from the fronthaul network 120 of the vDAS 100 to generate the uplink base station data for the base station 124. In exemplary embodiments shown in FIGS. 1A-1C, a respective vMU 112 does this for all of the served base stations 124. As a part of performing this processing, the vMU 112 can perform at least some of the user-plane combining or summing processes for the base station 124.

Also, for any base station 124 coupled to the vDAS 100 using a CPRI fronthaul interface or an Ethernet fronthaul interface, the associated vMU 112 (and/or VDI 132 or physical donor interface 126) is configured to appear to that base station 124 (that is, the associated BBU or DU) as a single RU or RRH of the type that the base station 124 is configured to work with (for example, as a CPRI RU or RRH where the associated BBU or DU is coupled to the vDAS 100 using a CPRI fronthaul interface or as an O-RAN, eCPRI, or RoE RU or RRH where the associated BBU or DU is coupled to the vDAS 100 using an O-RAN, eCPRI, or RoE fronthaul interface). As a part of doing this, the vMU 112 (and/or VDI 132 or physical donor interface 126) is configured to implement the control-plane, user-plane, synchronization-plane, and management-plane functions that such an RU or RRH would implement. Stated another way, in this example, the vMU 112 (and/or VDI 132 or physical donor interface 126) is configured to implement a single “virtual” RU or RRH for the associated base station 124 even though multiple APs 114 are actually being used to wirelessly transmit and receive RF signals for that base station 124.

In some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100. More specifically, in some implementations, whether user-plane data is communicated over the vDAS 100 as time-domain data or frequency-domain data depends on the functional split used to couple the associated donor base station 124 to the vDAS 100. That is, where the associated donor base station 124 is coupled to the vDAS 100 using functional split 7-2 (for example, where the associated donor base station 124 comprises an O-RAN DU that is coupled to the vDAS 100 using the O-RAN fronthaul interface), transport data communicated over the fronthaul network 120 of the vDAS 100 comprises frequency-domain user-plane data and any associated control-plane data. Where the associated donor base station 124 is coupled to the vDAS 100 using functional split 8 (for example, where the associated donor base station 124 comprises a CPRI BBU that is coupled to the vDAS 100 using the CPRI fronthaul interface) or where the associated donor base station 124 is coupled to the vDAS 100 using an analog RF interface (for example, where the associated donor base station 124 comprises a “complete” base station that is coupled to the vDAS 100 using the analog RF interface that otherwise can be used to couple the antenna ports of the base station to a set of antennas), transport data communicated over the fronthaul network 120 of the vDAS 100 comprises time-domain user-plane data and any associated control-plane data.

In some implementations, user-plane data is communicated over the vDAS 100 in one form (either as time-domain data or frequency-domain data) regardless of the functional split used to couple the associated donor base station 124 to the vDAS 100. For example, in some implementations, user-plane data is communicated over the vDAS 100 as frequency-domain data regardless of the functional split used to couple the associated donor base station 124 to the vDAS 100. Alternatively, user-plane data can be communicated over the vDAS 100 as time-domain data regardless of the functional split used to couple the associated donor base station 124 to the vDAS 100. In implementations where user-plane data is communicated over the vDAS 100 in one form, user-plane data is converted as needed (for example, by converting time-domain user-plane data to frequency-domain user-plane data and generating associated control-plane data or by converting frequency-domain user-plane data to time-domain user-plane data and generating associated control-plane data as needed).

In some such implementations, the same fronthaul interface can be used for transport data communicated over the fronthaul network 120 of the vDAS 100 for all the different types of donor base stations 124 coupled to the vDAS 100. For example, in implementations where user-plane data is communicated over the vDAS 100 in different forms, the O-RAN fronthaul interface can be used for transport data used to communicate frequency-domain user-plane data and any associated control-plane data for donor base stations 124 that are coupled to the vDAS 100 using functional split 7-2 and the O-RAN fronthaul interface can also be used for transport data used to communicate time-domain user-plane data and any associated control-plane data for donor base stations 124 that are coupled to the vDAS 100 using functional split 8 or using an analog RF interface. Also, in implementations where user-plane data is communicated over the vDAS 100 in one form (for example, as frequency-domain data), the O-RAN fronthaul interface can be used for all donor base stations 124 regardless of the functional split used to couple the associated donor base station 124 to the vDAS 100.

Alternatively, in some such implementations, different fronthaul interfaces can be used to communicate transport data for different types of donor base stations 124. For example, the O-RAN fronthaul interface can be used for transport data used to communicate frequency-domain user-plane data and any associated control-plane data for donor base stations 124 that are coupled to the vDAS 100 using functional split 7-2 and a proprietary fronthaul interface can be used for transport data used to communicate time-domain user-plane data and any associated control-plane data for donor base stations 124 that are coupled to the vDAS 100 using functional split 8 or using an analog RF interface.

In some implementations, transport data is communicated in different ways over different portions of the fronthaul network 120 of the vDAS 100. For example, the way transport data is communicated over portions of the fronthaul network 120 of the vDAS 100 implemented using switched Ethernet networking can differ from the way transport data is communicated over portions of the fronthaul network 120 of the vDAS 100 implemented using point-to-point Ethernet links 123 (for example, as a described below in connection with FIGS. 3A-3D).

In the exemplary embodiment shown in FIGS. 1A-1C, the vDAS 100, and each vMU 112, ICN 103, and AP 114 thereof, is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 100. In one example, one of the vMUs 112 is configured to serve as the timing master entity for the vDAS 100, and each of the other vMUs 112 and the ICNs and APs 114 synchronizes itself to that timing master entity. In another example, a separate external timing master entity is used, and each vMU 112, ICN, and AP 114 synchronizes itself to that external timing master entity. For example, a timing master entity for one of the base stations 124 may be used as the external timing master entity.

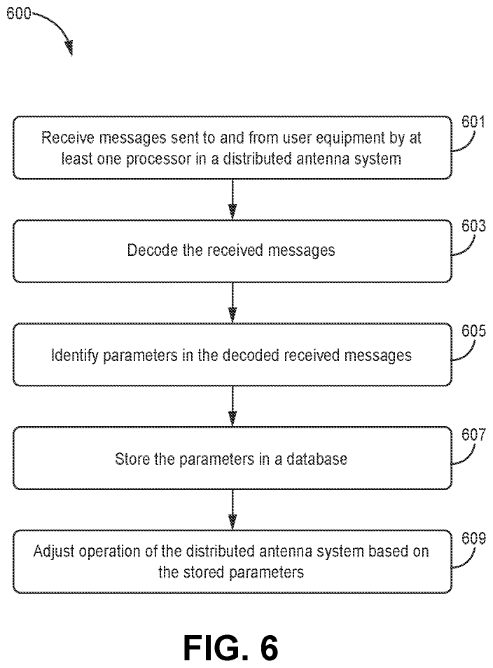

In the exemplary embodiment shown in FIGS. 1A-1C, each vMU 112 (and/or the associated VDIs 130) can also be configured to process the downlink user-plane and/or control-plane data for each donor base station 124 in order to determine timing and system information for the donor base station 124 and associated cell. This can involve processing the downlink user-plane and/or control-plane data for the donor base station 124 to perform the initial cell search processing a UE would typically perform in order to acquire time, frequency, and frame synchronization with the base station 124 and associated cell and to detect the Physical layer Cell ID (PCI) and other system information for the base station 124 and associated cell (for example, by detecting and/or decoding the Primary Synchronization Signal (PSS), the Secondary Synchronization Signal (SSS), the Physical Broadcast Channel (PBCH), the Master Information Block (MIB), and System Information Blocks (SIBs)). This timing and system information for a donor base station 124 can be used, for example, to configure the operation of the vDAS 100 (and the components thereof) in connection with serving that donor base station 124. For example, FIGS. 6A and 6B illustrate a method for acquiring the timing and system information for configuring the operation of the vDAS 100.

In order to reduce the latency associated with implementing each vMU 112 or ICN in a virtualized environment 108 running on a COTS physical server 104, input-output (IO) operations associated with communicating data between a vMU 112 and a physical donor interface 126 and/or between a vMU 112 and a physical transport interface 128, as well as any baseband processing performed by a vMU 112, associated VDI 130, or ICN 103 can be time-sliced to ensure that such operations are performed in a timely manner. With such an approach, the tasks and threads associated with such operations and processing are executed in dedicated time slices without such tasks and threads being preempted by, or otherwise having to wait for the completion of, other tasks or threads.

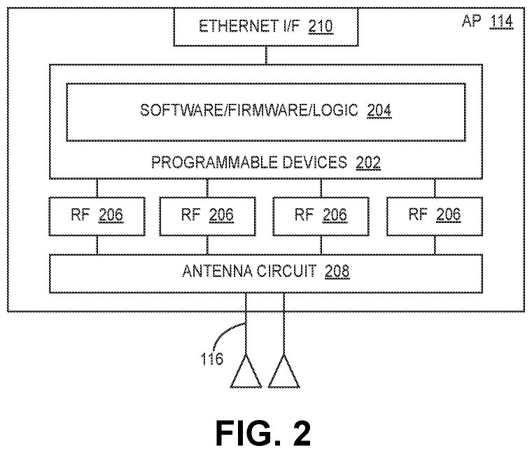

FIG. 2 is a block diagram illustrating one exemplary embodiment of an access point 114 that can be used in the vDAS 100 of FIGS. 1A-1C.

The AP 114 comprises one or more programmable devices 202 that execute, or are otherwise programmed or configured by, software, firmware, or configuration logic 204 in order to implement at least some functions described here as being performed by the AP 114 (including, for example, physical layer (Layer 1) baseband processing described here as being performed by a radio unit (RU) entity implemented using that AP 114). The one or more programmable devices 202 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way. In general, the programmable devices 202 and software, firmware, or configuration logic 204 are scaled so as to be able to implement multiple logical (or virtual) RU entities using the (physical) AP 114. The various functions described here as being performed by an RU entity are implemented by the programmable devices 202 and one or more of the RF modules 206 (described below) of the AP 114.

In general, each RU entity implemented by an AP 114 is associated with, and serves, one of the base stations 124 coupled to the vDAS 100. The RU entity communicates transport data with each vMU 112 serving that AP 114 using the particular fronthaul interface used for communicating over the fronthaul network 120 for the associated type of base station 124 and is configured to implement the associated fronthaul interface related processing (for example, formatting data in accordance with the fronthaul interface and implementing control-plane, management-plane, and synchronization-plane functions). The O-RAN fronthaul interface is used in some implementations of the exemplary embodiment described here in connection with FIGS. 1A-1C and 2. In addition, the RU entity performs any physical layer baseband processing that is required to be performed in the RU.

Normally, when a functional split 7-2 is used, some physical layer baseband processing is performed by the DU or BBU, and the remaining physical layer baseband processing and the RF functions are performed by the corresponding RU. The physical layer baseband processing performed by the DU or BBU is also referred to as the “high” physical layer baseband processing, and the baseband processing performed by the RU is also referred to as the “low” physical layer baseband processing.

As noted above, in some implementations, the content of the transport data communicated between each AP 114 and a serving vMU 112 depends on the functional split used by the associated base station 124. That is, where the associated base station 124 comprises a DU or BBU that is configured to use a functional split 7-2, the transport data comprises frequency-domain user-plane data (and associated control-plane data), and the RU entity for that base station 124 performs the low physical layer baseband processing and the RF functions in addition to performing the processing related to communicating the transport data over the fronthaul network 120 of the vDAS 100. Where the associated base station 124 comprises a DU or BBU that is configured to use functional split 8 or where the associated base station 124 comprises a “complete” base station that is coupled to a vMU 112 using an analog RF interface, the transport data comprises time-domain user-plane data (and associated control-plane data) and the RU entity for that base station 124 performs the RF functions for the base station 124 in addition to performing the processing related to communicating the transport data over the fronthaul network 120 of the vDAS 100.

It is possible for a given AP 114 to communicate and process transport data for different base stations 124 served by that AP 114 in different ways. For example, a given AP 114 may serve a first base station 124 that uses functional split 7-2 and a second base station 124 that uses functional split 8, in which case the corresponding RU entity implemented in that AP 114 for the first base station 124 performs the low physical layer processing for the first base station 124 (including, for example, the inverse fast Fourier transform (iFFT) processing for the downlink data and the fast Fourier transform (FFT) processing for the uplink data), whereas the corresponding RU entity implemented in the AP 114 for the second base station 124 does not perform such low physical layer processing for the second base station 124.

In other implementations, the content of the transport data communicated between each AP 114 and each serving vMU 112 is the same regardless of the functional split used by the associated base station 124. For example, in one such implementation, the transport data communicated between each AP 114 and a serving vMU 112 comprises frequency-domain user-plane data (and associated control-plane data), regardless of the functional split used by the associated base station 124. In such implementations, the vMU 112 converts the user-plane data as needed (for example, by converting the time-domain user-plane data to frequency-domain user-plane data and generating associated control-plane data).

In general, the physical layer baseband processing required to be performed by an RU entity for a given served base station 124 depends on the functional split used for the transport data.

In the exemplary embodiment shown in FIG. 2, the AP 114 comprises multiple radio frequency (RF) modules 206. Each RF module 206 comprises circuitry that implements the RF transceiver functions for a given RU entity implemented using that physical AP 114 and provides an interface to the coverage antennas 116 associated with that AP 114. Each RF module 206 can be implemented using one or more RF integrated circuits (RFICs) and/or discrete components.

Each RF module 206 comprises circuitry that implements, for the associated RU entity, a respective downlink and uplink signal path for each of the coverage antennas 116 associated with that physical AP 114. In one exemplary implementation, each downlink signal path receives the downlink baseband IQ data output by the one or more programmable devices 202 for the associated coverage antenna 116, converts the downlink baseband IQ data to an analog signal (including the various physical channels and associated sub carriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated coverage antenna 116 via an antenna circuit 208 (which implements any needed frequency-division duplexing (FDD) or time-division-duplexing (TDD) functions), including filtering and combining.

In one exemplary implementation, the uplink RF analog signal (including the various physical channels and associated sub-carriers) received by each coverage antenna 116 is provided, via the antenna circuit 208, to an associated uplink signal path in each RF module 206.

Each uplink signal path in each RF module 206 receives the uplink RF analog signal received via the associated coverage antenna 116, low-noise amplifies the uplink RF analog signal, and, if necessary, filters and, if necessary, down-converts the resulting signal to produce an intermediate frequency (IF) or zero IF version of the signal.

Each uplink signal path in each RF module 206 converts the resulting analog signals to real or IQ digital samples and outputs them to the one or more programmable logical devices 202 for uplink signal processing. (The analog-to-digital conversion process can be implemented using a direct RF ADC that can receive and digitize RF signals, in which case no analog down-conversion is necessary.)

Also, in this exemplary embodiment, for each coverage antenna 116, the antenna circuit 208 is configured to combine (for example, using one or more band combiners) the amplified analog RF signals output by the appropriate downlink signal paths of the various RF modules 206 for transmission using each coverage antenna 116 and to output the resulting combined signal to that coverage antenna 116. Likewise, in this exemplary embodiment, for each coverage antenna 116, the antenna circuit 208 is configured to split (for example, using one or more band filters and/or RF splitters) the uplink analog RF signals received using that coverage antenna 116 in order to supply, to the appropriate uplink signal paths of the RF modules 206 used for that antenna 116, a respective uplink analog RF signals for that signal path.

It is to be understood that the preceding description is one example of how each downlink and uplink signal path of each RF module 206 can be implemented; it is to be understood, however, that the downlink and uplink signal paths can be implemented in other ways.

The AP 114 further comprises at least one Ethernet interface 210 that is configured to communicatively couple the AP 114 to the fronthaul network 120 and, ultimately, to the vMU 112. For each port of each Ethernet interface 210, the Ethernet 210 is configured to communicate over a switched Ethernet network or over a point-to-point Ethernet link depending on how the fronthaul network 120 is implemented (more specifically, depending on whether the particular Ethernet cabling connected to that port is being used to implement a part of a switched Ethernet network or is being used to implement a point-to-point Ethernet link).

In one example of the operation of the vDAS 100 of FIGS. 1A-1C and 2, each base station 124 coupled to the vDAS 100 is served by a respective set of APs 114. As noted above, the set of APs 114 serving each base station 124 is also referred to here as the “simulcast zone” for that base station 124 and different base stations 124 (including different base stations 124 from different wireless service operators in deployments where multiple wireless service operators share the same vDAS 100) can have different simulcast zones defined for them.

In the downlink direction, one or more downlink base station signals from each base station 124 are received by a physical donor interface 126 of the vDAS 100, which generates downlink base station data using the received downlink base station signals and provides the downlink base station data to the associated vMU 112.

The form that the downlink base station signals take and how the downlink base station data is generated from the downlink base station signals depends on how the base station 124 is coupled to the vDAS 100.

For example, where the base station 124 is coupled to the vDAS 100 using an analog RF interface, the base station 124 is configured to output from its antenna ports a set of downlink analog RF signals. Thus, in this example, the one or more downlink base station signals comprise the set of downlink analog RF signals output by the base station 124 that would otherwise be radiated from a set of antennas coupled to the antenna ports of the base station 124. In this example, the physical donor interface 126 used to receive the downlink base station signals comprises a physical RF donor interface 134. Each of the downlink analog RF signals is received by a respective RF port of the physical RF donor interface 134 installed in the physical server computer 104 executing the vMU 112. The physical RF donor interface 134 is configured to receive each downlink analog RF signal (including the various physical channels and associated sub-carriers) output by the base station 124 and generate the downlink base station data by generating corresponding time-domain baseband in-phase and quadrature (IQ) data from the received download analog RF signals (for example, by performing an analog-to-digital (ADC) and digital down-conversion process on the received downlink analog RF signal). The generated downlink base station data is provided to the vMU 112 (for example, by communicating it over a PCIe lane to a CPU used to execute the vMU 112).

In another example, the base station 124 comprises a BBU or DU that is coupled to the vDAS 100 using a CPRI fronthaul interface. In this example, the one or more downlink base station signals comprise the downlink CPRI fronthaul signal output by the base station 124 that would otherwise be communicated over a CPRI link to an RU. In this example, the physical donor interface 126 used to receive the one or more downlink base station signals comprises a physical CPRI donor interface 138. Each downlink CPRI fronthaul signal is received by a CPRI port of the physical CPRI donor interface 138 installed in the physical server computer 104 executing the vMU 112. The physical CPRI donor interface 138 is configured to receive each downlink CPRI fronthaul signal, generate downlink base station data by extracting various information flows that are multiplexed together in CPRI frames or messages that are communicated via the downlink CPRI fronthaul signal, and provide the generated downlink base station data to the vMU 112 (for example, by communicating it over a PCIe lane to a CPU used to execute the vMU 112). The extracted information flows can comprise CPRI user-plane data, CPRI control-and-management-plane data, and CPRI synchronization-plane data. That is, in this example, the downlink base station data comprises the various downlink information flows extracted from the downlink CPRI frames received via the downlink CPRI fronthaul signals. Alternatively, the downlink base station data can be generated by extracting downlink CPRI frames or messages from each received downlink CPRI fronthaul signal, where the extracted CPRI frames are provided to the vMU 112 (for example, by communicating them over a PCIe lane to a CPU used to execute the vMU 112).

In another example, the base station 124 comprises a BBU or DU that is coupled to the vDAS 100 using an Ethernet fronthaul interface (for example, an O-RAN, eCPRI, or RoE fronthaul interface). In this example, the one or more downlink base station signals comprise the downlink Ethernet fronthaul signals output by the base station 124 (that is, the BBU or DU) that would otherwise be communicated over an Ethernet network to an RU. In this example, the physical donor interface 126 used to receive the one or more downlink base station signals comprises a physical Ethernet donor interface 142. The physical Ethernet donor interface 142 is configured to receive the downlink Ethernet fronthaul signals, generate the downlink base station data by extracting the downlink messages communicated using the Ethernet fronthaul interface, and provide the messages to the vMU 112 (for example, by communicating them over a PCIe lane to a CPU used to execute the vMU 112). That is, in this example, the downlink base station data comprises the downlink messages extracted from the downlink Ethernet fronthaul signals.

The vMU 112 generates downlink transport data using the received downlink base station data and communicates, using a physical transport Ethernet interface 146, the downlink transport data from the vMU 112 over the fronthaul network 120 to the set of APs 114 serving the base station 124. As described above, the downlink transport data for each base station 124 can be communicated to each AP 114 in the base station's simulcast zone via one or more intermediary units of the vDAS 100 (such as one or more ICNs or daisy-chained APs 114).

The downlink transport data generated for a base station 124 is communicated by the vMU 112 over the fronthaul network 120 so that downlink transport data for the base station 124 is received at the APs 114 included in the simulcast zone of that base station 124. In one example, a multicast group is established for each different simulcast zone assigned to any base station 124 coupled to the vDAS 100. In such an example, the vMU 112 communicates the downlink transport data to the set of APs 114 serving the base station 124 by using one or more of the physical transport Ethernet interfaces 146 to transmit the downlink transport data as transport Ethernet packets addressed to the multicast group established for the simulcast zone associated with that base station 124. In this example, the vMU 112 is configured so that a part of the process of generating the downlink transport data includes formatting the transport Ethernet packets to use the address of the multicast group established for that simulcast zone. In another example, a separate virtual local area network (VLAN) is established for each different simulcast zone assigned to any base station 124 coupled to the vDAS 100, where only the APs 114 included in the associated simulcast zone and the associated vMUs 112 communicate data using that VLAN. In such an example, each vMU 112 is configured so that a part of the process of generating the downlink transport data includes formatting the transport Ethernet packets to be communicated with the VLAN established for that simulcast zone.

In another example, the vMU 112 broadcasts the downlink transport data to all of APs 114 of the vDAS 100 and each AP 114 is configured to determine if any downlink transport data it receives is intended for it. In this example, this can be done by including in the downlink transport data broadcast to the APs 114 a bitmap field that includes a respective bit position for each AP 114 included in the vDAS 100. Each bit position is set to one value (for example, a “1”) if the associated downlink transport data is intended for that AP 114 and is set to a different value (for example, a “0”) if the associated downlink transport data is not intended for that AP 114. In one such example, the bitmap is included in a header portion of the underlying message so that the AP 114 does not need to decode the entire message in order to determine if the associated message is intended for it or not. In one implementation where the O-RAN fronthaul interface is used for the transport data, this can be done using an O-RAN section extension that is defined to include such a bitmap field in the common header fields. In this example, the vMU 112 is configured so that a part of the process of generating the downlink transport data includes formatting the downlink transport data to include a bitmap field, where the bit position for each AP 114 included in the base station's simulcast zone is set to the value (for example, a “1”) indicating that the data is intended for it and where the bit position for each AP 114 not included in the base station's simulcast zone is set to the other value (for example, a “0”) indicating that the data is not intended for it.

As a part of generating the downlink transport data, the vMU 112 performs any needed re-formatting or conversion of the received downlink base station data in order for it to comply with the format expected by the APs 114 or for it to be suitable for use with the fronthaul interface used for communicating over the fronthaul network 120 of the vDAS 100. For example, in one exemplary embodiment described here in connection with FIGS. 1A-1C and 2 where the vDAS 100 is configured to use an O-RAN fronthaul interface for communications between the vMU 112 and the APs 114, the APs 114 are configured for use with, and to expect, fronthaul data formatted in accordance with the O-RAN fronthaul interface. In such an example, if the downlink base station data provided from the physical donor interface 126 to the vMU 112 is not already formatted in accordance with the O-RAN fronthaul interface, the vMU 112 re-formats and converts the downlink base station data so that the downlink transport data communicated to the APs 114 in the simulcast zone of the base station 124 is formatted in accordance with the O-RAN fronthaul interface used by the APs 114.

As noted above, in some implementations, the content of the transport data and the manner it is generated depend on the functional split and/or fronthaul interface used to couple the associated base station 124 to the vDAS 100 and, in other implementations, the content of the transport data and the manner in which it is generated is generally the same for all donor base stations 124, regardless of the functional split and/or fronthaul interface used to couple each donor base station 124 to the vDAS 100.

In those implementations where both the content of the transport data and the manner in which it is generated depend on the functional split and/or fronthaul interface used to couple the associated base station 124 to the vDAS 100, if the base station 124 comprises a DU or BBU that is coupled to the vDAS 100 using a functional split 7-2, the downlink transport data that is communicated between the vMU 112 and the APs 114 in the base station's simulcast zone comprises frequency-domain user-plane data and associated control-plane data for each antenna port of the base station 124. In such implementations, if a base station 124 comprises a DU or BBU that is coupled to the vDAS 100 using functional split 8 or where a base station 124 comprises a “complete” base station that is coupled to the vDAS 100 using an analog RF interface, the downlink transport data that is communicated between the vMU 112 and the APs 114 in the base station's simulcast zone comprises time-domain user-plane data and associated control-plane data for each antenna port of the base station 124.

In one example of an implementation where the content of the downlink transport data and the manner in which it is generated is generally the same for all donor base stations 124, regardless of the functional split and/or fronthaul interface used to couple each donor base station 124 to the vDAS 100, all downlink transport data is generated in accordance with a functional split 7-2 where the corresponding user-plane data is communicated as frequency-domain user-plane data. For example, where a base station 124 comprises a DU or BBU that is coupled to the vDAS 100 using functional split 8 or where a base station 124 comprises a “complete” base station that is coupled to the vDAS 100 using an analog RF interface, the downlink base station data for the base station 124 comprises time-domain user-plane data for each antenna port of the base station 124 and the vMU 112 converts it to frequency-domain user-plane data and generates associated control-plane data in connection with generating the downlink transport data that is communicated between each vMU 112 and each AP 114 in the base station's simulcast zone. This can be done in order to reduce the amount of bandwidth used to transport such downlink transport data over the fronthaul network 120 (relative to communicating such user-plane data as time-domain user-plane data).

Each of the APs 114 associated with the base station 124 receives the downlink transport data, generates a respective set of downlink analog RF signals using the downlink transport data, and wirelessly transmits the respective set of analog RF signals from the respective set of coverage antennas 116 associated with each such AP 114.

Where multicast addresses and/or VLANs are used for transmitting the downlink transport data to the APs 114 in a base station's simulcast zone, each AP 114 in the simulcast zone will receive the downlink transport data transmitted by the vMU 112 using that multicast address and/or VLAN.

Where downlink transport data is broadcast to all APs 114 of the vDAS 100 and the downlink transport data includes a bitmap field to indicate which APs 114 the data is intended for, all APs 114 for the vDAS 100 will receive the downlink transport data transmitted by the vMU 112 for a base station 124 but the bitmap field will be populated with data in which only the bit positions associated with the APs 114 in the base station's simulcast zone will be set to the bit value indicating that the data is intended for them and the bit positions associated with the other APs 114 will be set to the bit value indicating that the data is not intended for them. As a result, only those APs 114 in the base station's simulcast zone will fully process such downlink transport data, and the other APs 114 will discard the data after determining that it is not intended for them.

As noted above, how each AP 114 generates the set of downlink analog RF signals using the downlink transport data depends on the functional split used for communicating transport data between the vMUs 112 and the APs 114. For example, where the downlink transport data that is communicated between the vMU 112 and the APs 114 in the base station's simulcast zone comprises frequency-domain user-plane data and associated control-plane data for each antenna port of the base station 124, an RU entity implemented by each AP 114 is configured to perform the low physical layer baseband processing and RF functions for each antenna port of the base station 124 using the respective downlink transport data. This is done in order to generate a corresponding downlink RF signal for wireless transmission from a respective coverage antenna 116 associated with that AP 114. Where the downlink transport data that is communicated between the vMU 112 and the APs 114 in the base station's simulcast zone comprises time-domain user-plane data and associated control-plane data for each antenna port of the base station 124, an RU entity implemented by each AP 114 is configured to perform the RF functions for each antenna port of the base station 124 using the respective downlink transport data. This is done in order to generate a corresponding downlink RF signal for wireless transmission from a respective coverage antenna 116 associated with that AP 114.

In the uplink direction, each AP 114 included in the simulcast zone of a given base station 124 wirelessly receives a respective set of uplink RF analog signals (including the various physical channels and associated sub-carriers) via the set of coverage antennas 116 associated with that AP 114, generates uplink transport data from the received uplink RF analog signals and communicates the uplink transport data from each AP 114 over the fronthaul network 120 of the vDAS 100. The uplink transport data is communicated over the fronthaul network 120 to the vMU 112 coupled to the base station 124.

As noted above, how each AP 114 generates the uplink transport data from the set of uplink analog RF signals depends on the functional split used for communicating transport data between the vMUs 112 and the APs 114. Where the uplink transport data that is communicated between each AP 114 in the base station's simulcast zone and the serving vMU 112 comprises frequency-domain user-plane data for each antenna port of the base station 124, an RU entity implemented by each AP 114 is configured to perform the RF functions and low physical layer baseband processing for each antenna port of the base station 124 using the respective uplink analog RF signal. This is done in order to generate the corresponding uplink transport data for transmission over the fronthaul network 120 to the serving vMU 112. Where the uplink transport data that is communicated between each AP 114 in the base station's simulcast zone and the serving vMU 112 comprises time-domain user-plane data for each antenna port of the base station 124, an RU entity implemented by each AP 114 is configured to perform the RF functions for each antenna port of the base station 124 using the respective uplink analog RF signal. This is done in order to generate the corresponding uplink transport data for transmission over the fronthaul network 120 to the serving vMU 112.

The vMU 112 coupled to the base station 124 receives uplink transport data derived from the uplink transport data transmitted from the APs 114 in the simulcast zone of the base station 124, generates uplink base station data from the received uplink transport data, and provides the uplink base station data to the physical donor interface 126 coupled to the base station 124. The physical donor interface 126 coupled to the base station 124 generates one or more uplink base station signals from the uplink base station data and transmits the one or more uplink base station signals to the base station 124. As described above, the uplink transport data can be communicated from the APs 114 in the simulcast zone of the base station 124 to the vMU 112 coupled to the base station 124 via one or more intermediary units of the vDAS 100 (such as one or more ICNs or daisy-chained APs 114).

As described above, a single set of uplink base station signals are produced for each donor base station 124 using a combining or summing process that uses inputs derived from the uplink RF signals received via the coverage antennas 116 associated with the multiple APs 114 in that base station's simulcast zone, where the resulting final single set of uplink base station signals is provided to the base station 124. Also, as noted above, this combining or summing process can be performed in a centralized manner in which the combining or summing process for each base station 124 is performed by a single unit of the vDAS 100 (for example, by the associated vMU 112). This combining or summing process can also be performed for each base station 124 in a distributed or hierarchical manner in which the combining or summing process is performed by multiple units of the vDAS 100 (for example, the associated vMU 112 and one or more ICNs and/or APs 114).

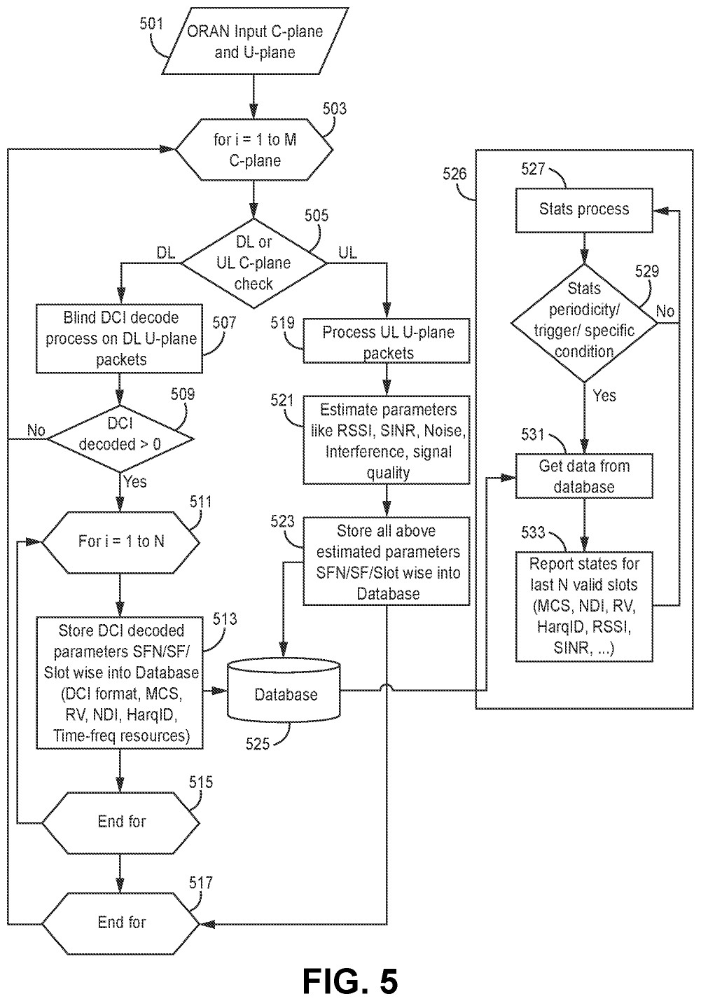

How the corresponding user-plane data is combined or summed depends on the functional split used for communicating transport data between the vMUs 112 and the APs 114 and can be performed as described below in connection with FIG. 5.

The form that the uplink base station signals take and how the uplink base station signals are generated from the uplink base station data also depend on how the base station 124 is coupled to the vDAS 100.

For example, where an Ethernet-based fronthaul interface is used (such as O-RAN, eCPRI, or RoE) to couple the base station 124 to the vDAS 100, the vMU 112 is configured to format the uplink base station data into messages formatted in accordance with the associated Ethernet-based fronthaul interface. The messages are provided to the associated physical Ethernet donor interface 142. The physical Ethernet donor interface 142 generates Ethernet packets for communicating the provided messages to the base station 124 via one or more Ethernet ports of that physical Ethernet donor interface 142. That is, in this example, the “uplink base station signals” comprise the physical-layer signals used to communicate such Ethernet packets.

Where a CPRI-based fronthaul interface is used for communications between the physical donor interface 126 and the base station 124, in one implementation, the uplink base station data comprises the various information flows that are multiplexed together in uplink CPRI frames or messages, and the vMU 112 is configured to generate these various information flows in accordance with the CPRI fronthaul interface. In such an implementation, the information flows are provided to the associated physical CPRI donor interface 138. The physical CPRI donor interface 138 uses these information flows to generate CPRI frames for communicating to the base station 124 via one or more CPRI ports of that physical CPRI donor interface 138. That is, in this example, the “uplink base station signals” comprise the physical-layer signals used to communicate such CPRI frames. Alternatively, in another implementation, the uplink base station data comprises CPRI frames or messages, which the VMU 112 is configured to produce and provide to the associated physical CPRI donor interface 138 for use in producing the physical-layer signals used to communicate the CPRI frames to the base station 124.

Where an analog RF interface is used for communications between the physical donor interface 126 and the base station 124, the vMU 112 is configured to provide the uplink base station data (comprising the combined (that is, digitally summed) time-domain baseband IQ data for each antenna port of the base station 124) to the associated physical RF donor interface 134. The physical RF donor interface 134 uses the provided uplink base station data to generate an uplink analog RF signal for each antenna port of the base station 124 (for example, by performing a digital up conversion and digital-to-analog (DAC) process). For each antenna port of the base station 124, the physical RF donor interface 134 outputs the respective uplink analog RF signal (including the various physical channels and associated sub-carriers) to that antenna port using the appropriate RF port of the physical RF donor interface 134. That is, in this example, the “uplink base station signals” comprise the uplink analog RF signals output by the physical RF donor interface 134.

By implementing one or more nodes or functions of a traditional DAS (such as a CAN or TEN) using, or as, one or more VNFs 102 executing on one or more physical server computers 104, such nodes or functions can be implemented using COTS servers (for example, COTS servers of the type deployed in data centers or “clouds” maintained by enterprises, communication service providers, or cloud services providers) instead of custom, dedicated hardware. As a result, such nodes and functions can be deployed more cheaply and in a more scalable manner (for example, additional capacity can be added by instantiating additional VNFs 102 as needed). This is the case even if an additional physical server computer 104 is needed in order to instantiate a new vMU 112 or ICN 103 because such physical server computers 104 are either already available in such deployments or can be easily added at a low cost (for example, because of the COTS nature of such hardware). Also, as noted above, this approach is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100).

Other embodiments can be implemented in other ways.

For example, FIGS. 3A-3D illustrate one such embodiment.

FIGS. 3A-3D are block diagrams illustrating one exemplary embodiment of vDAS 300 in which at least some of the APs 314 are coupled to one or more vMUs 112 serving them via one or more intermediate combining nodes (ICNs) 302. Each ICN 302 comprises at least one northbound Ethernet interface (NEI) 304 that couples the ICN 302 to Ethernet cabling used primarily for communicating with the one or more vMUs 112 and a plurality of southbound Ethernet interfaces (SEIs) 306 that couples the ICN 302 to Ethernet cabling used primarily for communicating with one or more of the plurality of APs 314.

Except as explicitly described here in connection with FIGS. 3A-3D, the vDAS 300 and the components thereof (including the vMU 112) are configured as described above. Also, except as explicitly described here in connection with FIGS. 3A-3D, each AP 314 is implemented in the same manner as the APs 114 described above.

The ICN 302 comprises one or more programmable devices 310 that execute, or are otherwise programmed or configured by, software, firmware, or configuration logic 312 in order to implement at least some of the functions described here as being performed by an ICN 302 (including, for example, any necessary physical layer (Layer 1) baseband processing). The one or more programmable devices 310 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The ICN 302 can be implemented as a physical network function using dedicated, special-purpose hardware. Alternatively, the ICN 302 can be implemented as a virtual network function running on a physical server. For example, the ICN 302 can be implemented in the same manner as the vMU 112 described above in connection with FIG. 1.

As noted above, the fronthaul network 320 used for transport between each vMU 112 and the APs 114 and ICNs 302 (and the APs 314 coupled thereto) can be implemented in various ways. Various examples of how the fronthaul network 320 can be implemented are illustrated in FIGS. 3A-3D. In the example shown in FIG. 3A, the fronthaul network 320 is implemented using a switched Ethernet network 322 that is used to communicatively couple each AP 114 and each ICN 302 (and the APs 314 coupled thereto) to each vMU 112 serving that AP 114 or 314 or ICN 302.

In the example shown in FIG. 3B, the fronthaul network 320 is implemented using only point-to-point Ethernet links 123 or 323, where each AP 114 and each ICN 302 (and the APs 314 coupled thereto) is coupled to each serving vMU 112 serving it via a respective one or more point-to-point Ethernet links 123 or 323. In the example shown in FIG. 3C, the fronthaul network 320 is implemented using a combination of a switched Ethernet network 322 and point-to-point Ethernet links 123 or 323. In the example shown in FIG. 3D, a first ICN 302 has a second ICN 302 subtended from it so that some APs 314 are communicatively coupled to the first ICN 302 via the second ICN 302. Again, as noted above, it is to be understood that FIGS. 1A-1C and 3A-3D illustrate only a few examples of how the fronthaul network (and the vDAS more generally) can be implemented and that other variations are possible.

In one implementation, each vMU 112 that serves the ICN 302 treats the ICN 302 as one or more “virtual APs” to which it sends downlink transport data for one or more base stations 124, and from which it receives uplink transport data, for the one or more base stations 124. The ICN 302 forwards the downlink transport data to, and combines uplink transport data received from, one or more of the APs 314 coupled to the ICN 302. In one implementation of such an embodiment, the ICN 302 forwards the downlink transport data it receives for all the served base stations 124 to all of the APs 314 coupled to the ICN 302 and combines uplink transport data it receives from all of the APs 314 coupled to the ICN 302 for all of the base stations 124 served by the ICN 302.

In another implementation, the ICN 302 is configured so that a separate subset of the APs 314 coupled to that ICN 302 can be specified for each base station 124 served by that ICN 302. In such an implementation, for each base station 124 served by an ICN 302, the ICN 302 forwards the downlink transport data it receives for that base station 124 to the respective subset of the APs 314 specified for that base station 124 and combines the uplink transport data it receives from the subset of the APs 314 specified for that base station 124. That is, in this implementation, each ICN 302 can be used to forward the downlink transport data for different served base stations 124 to different subsets of APs 314 and to combine uplink transport data the ICN 302 receives from different subsets of APs 314 for different served base stations 124. Various techniques can be used to do this. For example, the ICN 302 can be configured to inspect one or more fields (or other parts) of the received transport data to identify which base station 124 the transport data is associated with. In another implementation, the ICN 302 is configured to appear as different virtual APs for different served base stations 124 and is configured to inspect one or more fields (or other parts) of the received transport data to identify which virtual AP the transport data is intended for.

In the exemplary embodiments shown in FIGS. 3A-3D, each ICN 302 is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 300 by communicating over the switched Ethernet network 122. Each AP 314 coupled to an ICN 302 is configured to synchronize itself to the time base used in the rest of the vDAS 300 based on the synchronous Ethernet communications provided from the ICN 302.

In one example of the operation of the vDAS 300 of FIGS. 3A-3D, in the downlink direction, each ICN 302 receives downlink transport data for the base stations 124 served by that ICN 302 and communicates, using the southbound Ethernet interfaces 306 of the ICN 302, the downlink transport data to one or more of the APs 314 coupled to ICN 302. As noted above, in one implementation, each vMU 112 that is coupled to a base station 124 served by an ICN 302 treats the ICN 302 as a virtual AP and addresses downlink transport data for that base station 124 to the ICN 302, which receives it using the northbound Ethernet interface 304.

As noted above, for each served base station 124, the ICN 302 forwards the downlink transport data it receives from the serving vMU 112 for that base station 124 to one or more of the APs 314 coupled to the ICN 302. For example, as noted above, the ICN 302 can be configured to simply forward the downlink transport data it receives for all served base stations 124 to all of the APs 314 coupled to the ICN 302 or the ICN 302 can be configured so that a separate subset of the APs 314 coupled to the ICN 302 can be specified for each served base station 124, where the ICN 302 is configured to forward the downlink transport data it receives for each served base station 124 to only the specific subset of APs 314 specified for that base station 124.

Each AP 314 coupled to the ICN 302 receives the downlink transport data to it, generates respective sets of downlink analog RF signals for all base stations 124 served by the ICN 302, and wirelessly transmits the downlink analog RF signals for all of the served base stations 124 from the set of coverage antennas 116 associated with the AP 314.

Each such AP 314 generates the respective set of downlink analog RF signals for all of the base stations 124 served by the ICN 302 as described above. That is, how each AP 314 generates the set of downlink analog RF signals using the downlink transport data depends on the functional split used for communicating transport data between the vMUs 112, ICNs 302, and the APs 114 and 314. For example, where the downlink transport data comprises frequency-domain user-plane data and associated control-plane data for each antenna port of the base station 124, an RU entity implemented by each AP 314 is configured to perform the low physical layer baseband processing and RF functions for each antenna port of the base station 124 using the respective downlink transport data. This is done in order to generate a corresponding downlink RF signal for wireless transmission from a respective coverage antenna 316 associated with that AP 314. Where the downlink transport data comprises time-domain user-plane data and associated control-plane data for each antenna port of the base station 124, an RU entity implemented by each AP 314 is configured to perform the RF functions for each antenna port of the base station 124 using the respective downlink transport data. This is done in order to generate a corresponding downlink RF signal for wireless transmission from a respective coverage antenna 316 associated with that AP 314.

In the uplink direction, each AP 314 coupled to the ICN 302 that is used to serve a base station 124 receives a respective set of uplink RF analog signals (including the various physical channels and associated sub-carriers) for that served base station 124. The uplink RF analog signals are received by the AP 314 via the set of coverage antennas 116 associated with that AP 314. Each such AP 314 generates respective uplink transport data from the received uplink RF analog signals for the served base station 124 and communicates, using the respective Ethernet interface 210 of the AP 314, the uplink transport data to the ICN 302.

Each such AP 314 generates the respective uplink transport data from the received uplink analog RF signals for each served base station 124 served by the AP 314 as described above. That is, how each AP 314 generates the uplink transport data from the set of uplink analog RF signals depends on the functional split used for communicating transport data between the vMUs 112, ICNs 302, and the APs 114 and 314. Where the uplink transport data comprises frequency-domain user-plane data, an RU entity implemented by each AP 314 is configured to perform the RF functions and low physical layer baseband processing for each antenna port of the base station 124 using the respective uplink analog RF signal. This is done in order to generate the corresponding uplink transport data for transmission to the ICN 302. Where the uplink transport data comprises time-domain user-plane data, an RU entity implemented by each AP 314 is configured to perform the RF functions for each antenna port of the base station 124 using the respective uplink analog RF signal. This is done in order to generate the corresponding uplink transport data for transmission to the ICN 302.

The ICN 302 receives respective uplink transport data transmitted from any subtended APs 314 or other ICNs 302. The respective uplink transport data transmitted from any subtended APs 314 and/or subtended ICNs 302 is received by the ICN 302 using the respective southbound Ethernet interfaces 306.

The ICN 302 extracts the respective uplink transport data for each served base station 124 and, for each served base station 124, combines or sums corresponding user-plane data included in the extracted uplink transport data received from the one or more subtended APs 314 and/or ICNs 302 coupled to that ICN 302 used to serve that base station 124. The manner in which each ICN 302 combines or sums the user-plane data depends on whether the user-plane data comprises time-domain data or frequency-domain data. Generally, the ICN 302 combines or sums the user-plane data in the same way that each vMU 112 does so (for example, as described below in connection with FIG. 5).

The ICN 302 generates uplink transport data for each served base station 124 that includes the respective combined user-plane data for that base station 124 and communicates the uplink transport data including combined user-plane data for each served base station 124 to the vMU 112 associated with that base station 124 or to an upstream ICN 302. In this exemplary embodiment described here in connection with FIGS. 3A-3D where the O-RAN fronthaul interface is used for communicating over the fronthaul network 120, each ICN 302 is configured to generate and format the uplink transport data in accordance with that O-RAN fronthaul interface.

The ICN 302 shown in FIGS. 3A-3D can be used to increase the number of APs 314 that can be served by each vMU 112 while reducing the processing and bandwidth load relative to directly connecting the additional APs 314 to each such vMU 112.

FIG. 4 is a block diagram illustrating one exemplary embodiment of vDAS 400 in which one or more physical donor RF interfaces 434 are configured to by-pass the vMU 112.

Except as explicitly described here in connection with FIG. 4, the vDAS 400 and the components thereof are configured as described above.

In the exemplary embodiment shown in FIG. 4, the vDAS 400 includes at least one “by-pass” physical RF donor interface 434 that is configured to bypass the vMU 112 and instead, for the base stations 124 coupled to that physical RF donor interface 434, have that physical RF donor interface 434 perform at least some of the functions described above as being performed by the vMU 112. These functions include, for the downlink direction, receiving a set of downlink RF analog signals from each base station 124 coupled to the by-pass physical RF donor interface 434, generating downlink transport data from the set of downlink RF analog signals and communicating the downlink transport data to one or more of the APs or ICNs and, in the uplink direction, receiving respective uplink transport data from one or more APs or ICNs, generating a set of uplink RF analog signals from the received uplink transport data (including performing any digital combining or summing of user-plane data), and providing the uplink RF analog signals to the appropriate base stations 124. In this exemplary embodiment, each by-pass physical RF donor interface 434 includes one or more physical Ethernet transport interfaces 448 for communicating the transport data to and from the APs 114 and ICNs. The vDAS 400 (and the by-pass physical RF donor interface 434) can be used with any of the configurations described above (including, for example, those shown in FIGS. 1A-1C and FIGS. 3A-3D).

Each by-pass physical RF donor interface 434 comprises one or more programmable devices 450 that execute, or are otherwise programmed or configured by, software, firmware, or configuration logic 452 in order to implement at least some of the functions described here as being performed by the by-pass physical RF donor interface 434 (including, for example, any necessary physical layer (Layer 1) baseband processing). The one or more programmable devices 450 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The by-pass physical RF donor interface 434 can be used to reduce the overall latency associated with serving the base stations 124 coupled to that physical RF donor interface 434.

In one implementation, the by-pass physical RF donor interface 434 is configured to operate in a fully standalone mode in which the by-pass physical RF donor interface 434 performs substantially all “master unit” processing for the donor base stations 124 and APs and ICNs that it serves. For example, in such a fully standalone mode, in addition to the processing associated with generating and communicating user-plane and control-plane data over the fronthaul network 120, the by-pass physical RF donor interface 434 can also execute software that is configured to use a time synchronization protocol (for example, the IEEE 1588 PTP or SyncE protocol) to synchronize the by-pass physical RF donor interface 434 to a timing master entity established for the vDAS 100. In such a mode, the by-pass physical RF donor interface 434 can itself serve as a timing master for the APs and other nodes (for example, ICNs) served by that by-pass physical RF donor interface 434 or instead have another entity serve as a timing master for the APs and other nodes (for example, ICNs) served by that by-pass physical RF donor interface 434.

In such a fully standalone mode, the by-pass physical RF donor interface 434 can also execute software that is configured to process the downlink user-plane and/or control-plane data for each donor base station 124 in order to determine timing and system information for the donor base station 124 and associated cell (which, as described, can involve processing the downlink user-plane and/or control-plane data to perform the initial cell search processing a UE would typically perform in order to acquire time, frequency, and frame synchronization with the base station 124 and associated cell and to detect the PCI and other system information for the base station 124 and associated cell (for example, by detecting and/or decoding the PSS, the SSS, the PBCH, the MIB, and SIBs). This timing and system information for a donor base station 124 can be used, for example, to configure the operation of the by-pass physical RF donor interface 434 and/or the vDAS 100 (and the components thereof) in connection with serving that donor base station 124. In such a fully standalone mode, the by-pass physical RF donor interface 434 can also execute software that enables the by-pass physical RF donor interface 434 to exchange management-plane messages with the APs and other nodes (for example, ICNs) served by that by-pass physical RF donor interface 434 as well as with any external management entities coupled to it.

In other modes of operation, at least some of the “master unit” processing for the donor base stations 124 and APs and ICNs that the by-pass physical RF donor interface 434 serves are performed by a vMU 112. For example, the vMU 112 can serve as a timing master and the by-pass physical RF donor interface 434 can execute software that causes the by-pass physical RF donor interface 434 to serve as a timing sub-ordinate and exchange timing messages with the vMU 112 to enable the by-pass physical RF donor interface 434 to synchronize itself to the timing master. In such other modes, the by-pass physical RF donor interface 434 can itself serve as a timing master for the APs and other nodes (for example, ICNs) served by that by-pass physical RF donor interface 434 or instead have the vMU 112 (or other entity) serve as a timing master for the APs and other nodes (for example, ICNs) served by that by-pass physical RF donor interface 434. In such other modes, the vMU 112 can also execute software that is configured to process the downlink user-plane and/or control-plane data for each donor base station 124 served by the by-pass physical RF donor interface 434 in order to determine timing and system information for the donor base station 124 and associated cell. In connection with doing this, the by-pass physical RF donor interface 434 provides the required downlink user-plane and/or control-plane data to the vMU 112. In such other modes, the vMU 112 can also execute software that enables it to exchange management-plane messages with the by-pass physical RF donor interface 434 and the APs and other nodes (for example, ICNs) served by the by-pass physical RF donor interface 434 as well as with any external management entities coupled to it. In such other modes, data or messages can be communicated between the by-pass physical RF donor interface 434 and the vMU 112, for example, over the fronthaul switched Ethernet network 122 (which is suitable if the by-pass physical RF donor interface 434 is physically separate from the physical server computer 104 used to execute the vMU 112) or over a PCIe lane to a CPU used to execute the vMU 112 (which is suitable if the by-pass physical RF donor interface 434 is implemented as a card inserted into a slot of the physical server computer 104 used to execute the vMU 112).

The by-pass physical RF donor interface 434 can be configured and used in other ways.

As noted above, various entities in the vDAS 100, 300, or 400 combine or sum uplink data. For example, in the exemplary embodiment described above in connection with FIG. 1, as a part of generating the uplink base station data for each uplink antenna port of a base station 124, the corresponding vMU 112 combines or sums corresponding user-plane data included in the uplink transport data received from APs 114 in the base station's simulcast zone. In the exemplary embodiment described above in connection with FIG. 3, each ICN 302 also performs uplink combining or summing in the same general manner that the vMU 112 does. Also, in the exemplary embodiment described above in connection with FIG. 4, each physical donor RF interface 434 that is configured to by-pass the vMU 112 also performs uplink combining or summing in the same general manner that the vMU 112 does. Moreover, any daisy-chained also performs uplink combining or summing.

In the following description, an entity that is configured to perform uplink combining or summing is also referred to as a “combining entity,” and each entity that is subtended from a combining entity and that transmits uplink transport data to the combining entity is also referred to here as a “source entity” for that combining entity. That is, a distributed antenna system serving a base station can be considered to comprise at least one combining entity and a plurality of source entities communicatively coupled to the combining entity and configured to source uplink data for the base station to the combining entity. Also, the combining entity can be considered a source entity for itself in those situations where the combining entity is configured to receive uplink RF signals via coverage antennas 116 associated with it (for example, where the combining entity is a “daisy-chained” AP 114).

FIG. 5 illustrates a method 500 for gathering performance parameters that can be performed by a processor to improve the performance of a DAS 100. For example, the method 500 proceeds at 501, where the processor within the DAS 100 (for example, the MU 112) may acquire ORAN input from the C-plane. Also, the processor may acquire ORAN input from the U-plane. After receiving C-plane and potentially U-plane data, the method 500 may proceed to 503, where the processor iterates through N different packets received from the C-plane.

In certain embodiments, the method 500 may proceed to 505, where the processor determines whether the C-plane packet is a downlink or an uplink C-plane packet. When the processor determines that the packet is a downlink packet, the method 500 may proceed to 507, where the processor may perform a blind decode of the DCI information in the identified DL U-plane packets. For example, the processor may use configuration data identified in the C-plane packet, to perform the blind decoding of the DCI in the DL U-plane packet. If no DCI data is decoded from the U-plane data, the method 500 returns to 503 to acquire the next C-plane packet.

In further embodiments, when the processor decodes a number (N) of DCI slots, the method 500 proceeds at 511, where the processor iterates through the N slots of DCI. For each of the N slots, the method 500 proceeds at 513, where the processor stores DCI decoded parameters into a database 525 based on system frame number (SFN), system frame (SF), slot, or other identifiers. For example, the decoded information contained in the DCIs may include information such as the format of the DCI, modulation corrections (MCS), redundancy version (RV) identification, new data indicators (NDI), HARQ ID, time-frequency resources, mapping type, frequency hopping, transmit power control (TPC), among other parameters decoded from the DCI. After acquiring the DCI information for a slot, the method 500 proceeds to 515, where the processor determines whether there are additional slots of DCI for acquiring DCI information. If there are more slots of DCI, the method 500 returns to 511. If there are no more additional slots, the method 500 proceeds to 517 to determine whether or not there are additional packets for decoding in the C-plane. If there are additional packets, the method returns to 503.

Returning to 505, the method 500 may determine that a packet is a UL C-plane and proceed at 519, where the processor processes the UL U-plane packets. When processing the UL U-plane packets, the method 500 may proceed at 521, where the processor estimates parameters like RSSI, SINR, noise interference, signal quality, among other parameters. When the processor has estimated the parameters, the method 500 proceeds at 523, where the method 500 at 523, where the processor stores the estimated parameters in the database according to SFN, SF, or slot. The method 500 then proceeds to 517 to determine whether or not there are additional packets for decoding in the C-plane. If there are additional packets, the method returns to 503.

In certain embodiments, the method 500 may include an independently executing statistics monitoring process 526. The statistics monitoring process 526 may be performed by the same processor that stores data on the database 525. However, the statistics monitoring processor may be a different processor within the DAS 100 or a processor outside the DAS 100 that is part of a base station 124, an operator, or processor on another connected system. As part of the statistics monitoring process 526, the processor may perform a statistics process 527 that adjusts operation of the network based on the statistics acquired from the database 525.

In certain embodiments, the statistics monitoring process 526 may proceed to 529, where the processor determines whether to access the database 525 for additional information. To determine whether to access information from the database 525, the processor may periodically acquire data from the 525. Alternatively, the processor may monitor a subset of the information stored in the database for a trigger or specific condition that indicates that the processor should access data from the database 525. As indicated by the end of a period or by detecting a trigger event or specific condition, the statistics monitoring process 526 may proceed at 531, where the processor acquires data from the database 525. After acquiring data from the database, the statistics monitoring process 526 may proceed at 533, where the processor reports states for the last N valid slots. The states may include MCS, NDI, RV, HARQ ID, RSSI, SINR, and the like. The reported states are then processed to improve the operation of the network.

Although the above example was described as being implemented for use with a donor base station entity that is coupled to the DAS using an O-RAN interface, it is to be understood that the solution described here is not limited to such an example. For example, the solution described here can be used with donor base station entities that are coupled to the DAS using other packet based fronthaul interfaces (such as eCPRI or RoE). Also, the solution described here can be used with donor base station entities that are coupled to the DAS using another analog RF interface or a CPRI interface (for example, where the fronthaul data is processed to recover the appropriate control-plane or control-channel information and user-plane or shared channel data).

In certain embodiments, some components of the DAS 100, base stations 124, operators, and other external systems in communication with the DAS 100 may be or incorporate computation devices, such as a processor, that controls the operation of the DAS 100, monitors the performance of the DAS 100, and collects performance statistics for the DAS 100. The computation devices, that aid in performing the systems and methods described herein, may be implemented using software, firmware, hardware, or an appropriate combinations thereof. A processor and other computational devices may be supplemented by, or incorporated in, specially-designed application-specific integrated circuits (ASICs) or field programmable gate arrays (FPGAs). In some implementations, the computational devices may communicate through an additional transceiver with other computing devices outside of the DAS 100. The computational devices can also include or function with software programs, firmware, or other computer-readable instructions for carrying out various process tasks, calculations, and control functions used in the methods and systems described herein.

The methods described herein may be implemented by computer-executable instructions or code, such as program modules or components, which are executed by at least one processor. Generally, program modules include routines, programs, objects, data components, data structures, algorithms, and the like, which perform particular tasks or implement particular abstract data types.

Instructions for carrying out the various process tasks, calculations, and generation of other data used in the operation of the methods described herein can be implemented in software, firmware, or other computer-readable instructions. These instructions are typically stored on appropriate computer program products that include computer-readable media used to store computer-readable instructions or data structures. Such a computer-readable medium may be available media that can be accessed by a general-purpose or special-purpose computer or processor, or any programmable logic device. Also, a computer-readable medium may also be used for the database 525 for storing the gathered statistics.

Suitable computer-readable storage media may include, for example, non-volatile memory devices including semi-conductor memory devices such as Random Access Memory (RAM), Read Only Memory (ROM), Electrically Erasable Programmable ROM (EEPROM), or flash memory devices; magnetic disks such as internal hard disks or removable disks; optical storage devices such as compact discs (CDs), digital versatile discs (DVDs), Blu-ray discs; or any other media that can be used to carry or store desired program code in the form of computer-executable instructions or data structures.

FIG. 6 illustrates flowchart diagram of a method 600 for collecting base station performance statistics. A method 600 proceeds at 601, where messages sent to and from user equipment are received by at least one processor in a distributed antenna system. Further, the method 600 proceeds at 603, where the received messages are decoded. Additionally, the method 600 proceeds at 605, where parameters are identified in the decoded received messages. Also, the method 600 proceeds at 607, where the parameters are stored in a database. Moreover, the method 600 proceeds at 609, where operation of the distributed antenna system are adjusted based on the stored parameters.

### EXAMPLE EMBODIMENTS

Example 1 includes a system comprising: a distributed antenna system comprising at least one processor, wherein executable code directs the at least one processor to decode messages from and to user equipment in communication with the distributed antenna system; and a database, wherein the at least one processor stores parameters identified in the decoded messages in the database; wherein performance of the distributed antenna system is adjusted based on the stored parameters.

Example 2 includes the system of Example 1, wherein the messages comprise C-plane data and U-plane data.

Example 3 includes the system of Example 2, wherein the executable code directs the at least one processor to determine whether the C-plane data is at least one of downlink C-plane data and uplink C-plane data.

Example 4 includes the system of Example 3, when the at least one processor determines that the C-plane data is the downlink C-plane data, the executable code directs the at least one processor to: decode downlink U-plane data from the U-plane data; decode downlink correction information (DCI) in the downlink U-plane data; and identify the parameters in the DCI.

Example 5 includes the system of Example 4, wherein the parameters identified in the DCI comprise at least one of: DCI format; modulation and coding scheme (MCS); redundancy version (RV); new data indicators (NDI); hybrid automatic repeat request (HARQ) ID; and Time-frequency resources.

Example 6 includes the system of any of Examples 3-5, when the at least one processor determines that the C-plane data is the uplink C-plane data, the executable code directs the at least one processor to estimate the parameters from the U-plane data.

Example 7 includes the system of Example 6, wherein the parameters estimated from the U-plane data comprise at least one of: received signal strength indicator (RSSI); signal to interference and noise ratio (SINR); noise; interference; and signal quality.

Example 8 includes the system of any of Examples 1-7, wherein the parameters are stored in the database according to at least one of: system frame number (SFN); system frame (SF); and slot.

Example 9 includes the system of any of Examples 1-8, wherein the stored parameters are read by a device from the database in response to at least one of: an end to a period; a trigger event; and a specific condition.

Example 10 includes the system of Example 9, where the device reads the stored parameters that were received over a recent time period.

Example 11 includes the system of any of Examples 9-10, wherein the device is at least one of: the at least one processor; a base station coupled to the distributed antenna system; an operator for the distributed antenna system; and an external system coupled to the distributed antenna system.

Example 12 includes a method comprising: receiving messages sent to and from user equipment by at least one processor in a distributed antenna system; decoding the received messages; identifying parameters in the decoded received messages; storing the parameters in a database; and adjusting operation of the distributed antenna system based on the stored parameters.

Example 13 includes the method of Example 12, wherein the messages comprise C-plane data and U-plane data.

Example 14 includes the method of Example 13, further comprising: determining whether the C-plane data is at least one of downlink C-plane data and uplink C-plane data.

Example 15 includes the method of Example 14, when the C-plane data is determined to be the downlink C-plane data, further comprising: decoding downlink U-plane data; decoding downlink correction information (DCI) in the decoded downlink U-plane data; and identifying the parameters in the DCI.

Example 16 includes the method of Example 15, wherein the parameters identified in the DCI comprise at least one of: download correction information format; modulation and coding scheme (MCS); redundancy version (RV); new data indicators (NDI); hybrid automatic repeat request (HARQ) ID; and time-frequency resources.

Example 17 includes the method of any of Examples 14-16, when the C-plane data is determined to be the uplink C-plane data, further comprising estimating the parameters from the U-plane data.

Example 18 includes the method of Example 17, wherein the parameters estimated from the U-plane data comprise at least one of: received signal strength indicator (RSSI); signal to interference and noise ratio (SINR); noise; interference; and signal quality.

Example 19 includes the method of any of Examples 12-18, further comprising reading the stored parameters from the database in response to at least one of: an end to a period; a trigger event; and a specific condition.

Example 20 includes a system comprising: a distributed antenna system in communication with user equipment, wherein the distributed antenna system comprises at least one processor, wherein executable code directs the at least one processor to decode C-plane data and U-plane data in messages communicated from and to the user equipment; and a database; wherein the at least one processor stores parameters identified in the decoded messages in the database; wherein data is read from the database for adjusting performance of the distributed antenna system based on the stored parameters.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system comprising:
a distributed antenna system comprising at least one processor, wherein executable code directs the at least one processor to decode messages from and to user equipment in communication with the distributed antenna system; and
a database, wherein the at least one processor stores parameters identified in the decoded messages in the database;
wherein performance of the distributed antenna system is adjusted based on the stored parameters.

2. The system of claim 1, wherein the messages comprise C-plane data and U-plane data.

3. The system of claim 2, wherein the executable code directs the at least one processor to determine whether the C-plane data is at least one of downlink C-plane data and uplink C-plane data.

4. The system of claim 3, when the at least one processor determines that the C-plane data is the downlink C-plane data, the executable code directs the at least one processor to:
decode downlink U-plane data from the U-plane data;
decode downlink correction information (DCI) in the downlink U-plane data; and
identify the parameters in the DCI.

5. The system of claim 4, wherein the parameters identified in the DCI comprise at least one of:
DCI format;
modulation and coding scheme (MCS);
redundancy version (RV);
new data indicators (NDI);
hybrid automatic repeat request (HARQ) ID; and
Time-frequency resources.

6. The system of claim 3, when the at least one processor determines that the C-plane data is the uplink C-plane data, the executable code directs the at least one processor to estimate the parameters from the U-plane data.

7. The system of claim 6, wherein the parameters estimated from the U-plane data comprise at least one of:
received signal strength indicator (RSSI);
signal to interference and noise ratio (SINR);
noise;
interference; and
signal quality.

8. The system of claim 1, wherein the parameters are stored in the database according to at least one of:
system frame number (SFN);
system frame (SF); and
slot.

9. The system of claim 1, wherein the stored parameters are read by a device from the database in response to at least one of:
an end to a period;
a trigger event; and
a specific condition.

10. The system of claim 9, where the device reads the stored parameters that were received over a recent time period.

11. The system of claim 9, wherein the device is at least one of:
the at least one processor;
a base station coupled to the distributed antenna system;
an operator for the distributed antenna system; and
an external system coupled to the distributed antenna system.

12. A method comprising:
receiving messages sent to and from user equipment by at least one processor in a distributed antenna system;
decoding the received messages;
identifying parameters in the decoded received messages;
storing the parameters in a database; and
adjusting operation of the distributed antenna system based on the stored parameters.

13. The method of claim 12, wherein the messages comprise C-plane data and U-plane data.

14. The method of claim 13, further comprising:
determining whether the C-plane data is at least one of downlink C-plane data and uplink C-plane data.

15. The method of claim 14, when the C-plane data is determined to be the downlink C-plane data, further comprising:
decoding downlink U-plane data;
decoding downlink correction information (DCI) in the decoded downlink U-plane data; and
identifying the parameters in the DCI.

16. The method of claim 15, wherein the parameters identified in the DCI comprise at least one of:
download correction information format;
modulation and coding scheme (MCS);
redundancy version (RV);
new data indicators (NDI);
hybrid automatic repeat request (HARQ) ID; and
time-frequency resources.

17. The method of claim 14, when the C-plane data is determined to be the uplink C-plane data, further comprising estimating the parameters from the U-plane data.

18. The method of claim 17, wherein the parameters estimated from the U-plane data comprise at least one of:
received signal strength indicator (RSSI);
signal to interference and noise ratio (SINR);
noise;
interference; and
signal quality.

19. The method of claim 12, further comprising reading the stored parameters from the database in response to at least one of:
an end to a period;
a trigger event; and
a specific condition.

20. A system comprising:
a distributed antenna system in communication with user equipment, wherein the distributed antenna system comprises at least one processor, wherein executable code directs the at least one processor to decode C-plane data and U-plane data in messages communicated from and to the user equipment; and
a database;
wherein the at least one processor stores parameters identified in the decoded messages in the database;
wherein data is read from the database for adjusting performance of the distributed antenna system based on the stored parameters.
